(19) United States
(12) Patent Application Publication
(10) Pub. No.: US 2026/0365062 A1
(43) Pub. Date: Nov. 19, 2026

(54) PHASE CONTROL USING ISO 15118-2 FOR CHARGING AND DISCHARGING

(71) Applicant: Volvo Car Corporation, Gothenburg (SE)

(72) Inventors: Jones Schöld, Gothenburg (SE); Megha BENNUR, Gothenburg (SE); Vijay ARUMUGAM, Gothenburg (SE); Sourav SHAH, Gothenburg (SE)

(73) Assignee: Volvo Car Corporation, Gothenburg (SE)

(21) Appl. No.: 19/206,170

(22) Filed: May 13, 2025

(51) Int. Cl. B60L 53/62; B60L 53/66; B60L 53/68; B60L 55/00

(52) U.S. Cl. CPC B60L 53/62; B60L 53/66; B60L 53/68; B60L 55/00; B60L 2250/16

(57) ABSTRACT

Embodiments relate to phase control using ISO 15118-2 for charging and discharging and a system and method for the same. The system comprising: a memory storing program instructions; and a processor coupled to the memory and executing the program instructions stored in the memory, wherein the program instructions, when executed by the processor, causes the processor to: generate a message comprising a value of supply power for a vehicle along with at least one of a first indicator associated with a direction associated with the supply power, a second indicator associated with at least one of charging and discharging operation, a third indicator associated with a phase information of the supply power, and a fourth indicator associated with at least one of a set point and a maximum limit associated with the supply power; encode the generated message; and transmit the encoded message to the vehicle to perform at least one of a charging operation and a discharging operation based on information in the encoded message.

### TECHNICAL FIELD

This disclosure relates to the field of communication between a charging point and a vehicle. The disclosure is more particularly related to communicating information related to a grid code and phase based on a protocol.

### BACKGROUND

During charging or discharging of an electric vehicle using an international standards organization (ISO) 15118-2 protocol, the electric vehicle does not transmit any signal, and the communication is only from a charging point to the electric vehicle providing a supply power level. Lack of other information may result in blowing a fuse associated with the electric vehicle.

Therefore, there is a need for phase control using ISO 15118-2 for charging and discharging.

### SUMMARY

The following presents a summary to provide a basic understanding of one or more embodiments described herein. This summary is not intended to identify key or critical elements or delineate any scope of the different embodiments and/or any scope of the claims. The sole purpose of the summary is to present some concepts in a simplified form as a prelude to the more detailed description presented herein.

In an aspect the present disclosure relates to a system comprising: a memory storing program instructions; and a processor coupled to the memory and executing the program instructions stored in the memory, wherein the program instructions, when executed by the processor, causes the processor to: generate a message comprising a value of supply power for a vehicle along with at least one of a first indicator associated with a direction associated with the supply power, a second indicator associated with at least one of charging and discharging operation, a third indicator associated with a phase information of the supply power, and a fourth indicator associated with at least one of a set point and a maximum limit associated with the supply power; encode the generated message; and transmit the encoded message to the vehicle to perform at least one of a charging operation and a discharging operation based on information in the encoded message.

In another aspect the present disclosure relates to a method comprising: generating a message comprising a value of supply power for a vehicle along with at least one of a first indicator associated with a direction of the supply power, a second indicator associated with at least one of charging and discharging operation, a third indicator associated with a phase information of the supply power, and a fourth indicator associated with at least one of a set point and a maximum current limit associated with the supply power; encoding the generated message; and transmitting the encoded message to the vehicle to perform at least one of a charging operation and a discharging operation based on information in the encoded message.

In yet another aspect the present disclosure relates to a non-transitory computer-readable medium having stored thereon instructions executable by a processor to perform operations comprising: generating a message comprising a value of supply power for a vehicle along with at least one of a first indicator associated with a direction of the supply power, a second indicator associated with at least one of charging and discharging operation, a third indicator associated with a phase information of the supply power, and a fourth indicator associated with at least one of a set point and a maximum current limit associated with the supply power; encoding the generated message; and transmitting the encoded message to the vehicle to perform at least one of a charging operation and a discharging operation based on information in the encoded message.

In yet another aspect the present disclosure relates to a method comprising receiving an encoded message from a charging point, wherein the encoded message comprises a value of supply power for a vehicle along with at least one of a first indicator associated with a direction of the supply power, a second indicator associated with at least one of charging and discharging operation, a third indicator associated with a phase information of the supply power, and a fourth indicator associated with at least one of a set point and a maximum current limit associated with the supply power; decoding the encoded message from the charging point to obtain one or more information from the encoded message; and performing at least one of a charging operation and a discharging operation based on the obtained information.

In yet another aspect the present disclosure relates to a system comprising: a battery monitoring unit; and a processor communicatively coupled to the battery monitoring unit, wherein the battery monitoring unit is operable to: determine a charge level in a vehicle battery and communicate the determined charge level to the processor, wherein the processor is operable to: determine, based on the charge level, to perform at least one of charging the vehicle battery and discharging the vehicle battery; communicate to a charging point to perform charging based on the charge level below a threshold; receive from the charging point an encoded message comprising a value of supply power for a vehicle along with at least one of a first indicator associated with a direction of the supply power, a second indicator associated with at least one of charging and discharging operation, a third indicator associated with a phase information of the supply power, and a fourth indicator associated with a maximum limit associated with the supply power; and charge the vehicle battery based on information in the encoded message.

### BRIEF DESCRIPTION OF THE FIGURES

FIG. 1 illustrates a network diagram for communication between a charging point and a vehicle according to an embodiment.

FIG. 2 illustrates a block diagram of a system associated with a charging point according to an embodiment.

FIG. 3A illustrates a functional block diagram of a system associated with a vehicle according to an embodiment.

FIG. 3B illustrates a block diagram of electronic components of the vehicle according to an embodiment.

FIG. 4A illustrates a message flow diagram between the vehicle and the charging point according to an embodiment.

FIG. 4B illustrates the format of a first message according to an embodiment.

FIG. 4C illustrates the format of a second message according to an embodiment.

FIG. 4D illustrates the format of an encoded message according to an embodiment.

FIG. 5 illustrates the format of a lookup table according to an embodiment.

FIG. 6 illustrates a method of communicating grid codes according to an embodiment.

FIG. 7 illustrates a block diagram of the system implementing the method for communicating grid codes according to an embodiment.

FIG. 8 illustrates a block diagram of the method executed by the non-transitory computer-readable medium for communicating grid codes according to an embodiment.

FIG. 9 illustrates a block diagram of the system implementing a method for determining grid codes according to an embodiment.

FIG. 10 illustrates a flow chart describing a method for communicating charging and/or discharging information according to an embodiment.

FIG. 11 illustrates a block diagram of the system implementing the method for communicating charging and/or discharging information according to an embodiment.

FIG. 12 illustrates a block diagram of the method executed by the non-transitory computer-readable medium for communicating charging/discharging information according to an embodiment.

FIG. 13 illustrates a flow chart describing a method for determining how to perform a charging operation or a discharging operation according to an embodiment.

FIG. 14 illustrates a block diagram of the system implementing a method for determining to perform a charging operation or a discharging operation by the vehicle according to an embodiment.

FIG. 15 illustrates a flow chart describing a method of generating a first message and a second message by the charging point according to an embodiment.

FIG. 16 illustrates a block diagram of the system implementing the method of generating a first message and a second message by the charging point according to an embodiment.

FIG. 17 illustrates a block diagram of the method executed by the non-transitory computer-readable medium for generating a first message and a second message by the charging point according to an embodiment.

FIG. 18A illustrates the block diagram of the cyber security module in view of the system and server according to an embodiment.

FIG. 18B illustrates an embodiment of the cyber security module according to an embodiment.

FIG. 18C illustrates another embodiment of the cyber security module according to an embodiment.

### DETAILED DESCRIPTION

### Definitions and General Techniques

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items and may be used interchangeably with “one or more.” Furthermore, as used herein, the term “set” is intended to include items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As used herein, two or more elements or modules are “integral” or “integrated” if they operate functionally together. Two or more elements are “non-integral” if each element can operate functionally independently.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As used herein, the term “approximately” can mean within a specified or unspecified range of the specified or unspecified stated value. In some embodiments, “approximately” can mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As used herein the term “component” refers to a distinct and identifiable part, element, or unit within a larger system, structure, or entity. It is a building block that serves a specific function or purpose within a more complex whole. Components are often designed to be modular and interchangeable, allowing them to be combined or replaced in various configurations to create or modify systems. Components may be a combination of mechanical, electrical, hardware, firmware, software and/or other engineering elements.

Digital electronic circuitry, or computer software, firmware, or hardware, including the structures disclosed in this specification and their structural equivalents, or in combinations of one or more of them may realize the implementations and all of the functional operations described in this specification. Implementations may be as one or more computer program products i.e., one or more modules of computer program instructions encoded on a computer-readable medium for execution by, or to control the operation of, data processing apparatus. The computer-readable medium may be a machine-readable storage device, a machine-readable storage substrate, a memory device, a composition of matter affecting a machine-readable propagated signal, or a combination of one or more of them. The term “computing system” encompasses all apparatus, devices, and machines for processing data, including by way of example, a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal (e.g., a machine-generated electrical, optical, or electromagnetic signal) that encodes information for transmission to a suitable receiver apparatus.

The actual specialized control hardware or software code used to implement these systems and/or methods is not limiting to the implementations. Thus, any software and any hardware can implement the systems and/or methods based on the description herein without reference to specific software code.

A computer program (also known as a program, software, software application, script, or code) is written in any appropriate form of programming language, including compiled or interpreted languages. Any appropriate form, including a standalone program or a module, component, subroutine, or other unit suitable for use in a computing environment may deploy it. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may execute on one computer or on multiple computers that are located at one site or distributed across multiple sites and interconnected by a communication network.

One or more programmable processors, executing one or more computer programs to perform functions by operating on input data and generating output, perform the processes and logic flows described in this specification. The processes and logic flows may also be performed by, and apparatus may also be implemented as, special purpose logic circuitry, for example, without limitation, a Field-Programmable Gate Array (FPGA), an Application Specific Integrated Circuit (ASIC), Application Specific Standard Products (ASSPs), System-On-a-Chip (SOC) systems, Complex Programmable Logic Devices (CPLDs), etc.

Processors suitable for the execution of a computer program include, by way of example, both general and special purpose microprocessors, and any one or more processors of any appropriate kind of digital computer. A processor receives instructions and data from a read-only memory or a random-access memory or both. Elements of a computer can include a processor for performing instructions and one or more memory devices for storing instructions and data. A computer also includes, or is operatively coupled to receive data, transfer data or both, to/from one or more mass storage devices for storing data e.g., magnetic disks, magneto optical disks, optical disks, or solid-state disks. However, a computer need not have such devices. Moreover, another device, e.g., a mobile telephone, a personal digital assistant (PDA), a mobile audio player, a Global Positioning System (GPS) receiver, etc. may embed a computer. Computer-readable media suitable for storing computer program instructions and data include all forms of non-volatile memory, media and memory devices, including, by way of example, semiconductor memory devices (e.g., Erasable Programmable Read-Only Memory (EPROM), Electronically Erasable Programmable Read-Only Memory (EEPROM), and flash memory devices), magnetic disks (e.g., internal hard disks or removable disks), magneto optical disks (e.g. Compact Disk Read-Only Memory (CD-ROM) disks, Digital Versatile Disk-Read-Only Memory (DVD-ROM) disks) and solid-state disks. Special purpose logic circuitry may supplement or incorporate the processor and the memory.

To provide for interaction with a user, a computer may have a display device, e.g., a Cathode Ray Tube (CRT) or Liquid Crystal Display (LCD) monitor, for displaying information to the user, and a keyboard and a pointing device, e.g., a mouse or a trackball, by which the user may provide input to the computer. Other kinds of devices provide for interaction with a user as well. For example, feedback to the user may be any appropriate form of sensory feedback, e.g., visual feedback, auditory feedback, or tactile feedback; and a computer may receive input from the user in any appropriate form, including acoustic, speech, or tactile input.

A computing system that includes a back-end component, e.g., a data server, or that includes a middleware component, e.g., an application server, or that includes a front-end component, e.g., a client computer having a graphical user interface or a Web browser through which a user may interact with an implementation, or any appropriate combination of one or more such back-end, middleware, or front-end components, may realize implementations described herein. Any appropriate form or medium of digital data communication, e.g., a communication network may interconnect the components of the system. Examples of communication networks include a Local Area Network (LAN) and a Wide Area Network (WAN), e.g., Intranet and Internet.

The computing system may include clients and servers. A client and server are remote from each other and typically interact through a communication network. The relationship of the client and server arises by virtue of computer programs running on the respective computers and having a client-server relationship with each other.

Embodiments of the present disclosure may comprise or utilize a special purpose or general purpose computer including computer hardware. Embodiments within the scope of the present disclosure may also include physical and other computer-readable media for carrying or storing computer-executable instructions and/or data structures. Such computer-readable media can be any media accessible by a general purpose or special purpose computer system. Computer-readable media that store computer-executable instructions are physical storage media. Computer-readable media that carry computer-executable instructions are transmission media. Thus, by way of example and not limitation, embodiments of the disclosure can comprise at least two distinct kinds of computer-readable media: physical computer-readable storage media and transmission computer-readable media.

Although the present embodiments described herein are with reference to specific example embodiments it is evident that various modifications and changes may be made to these embodiments without departing from the broader spirit and scope of the various embodiments. For example, hardware circuitry (e.g., Complementary Metal Oxide Semiconductor (CMOS) based logic circuitry), firmware, software (e.g., embodied in a non-transitory machine-readable medium), or any combination of hardware, firmware, and software may enable and operate the various devices, units, and modules described herein. For example, transistors, logic gates, and electrical circuits (e.g., Application Specific Integrated Circuit (ASIC) and/or Digital Signal Processor (DSP) circuit) may embody the various electrical structures and methods.

In addition, a non-transitory machine-readable medium and/or a system may embody the various operations, processes, and methods disclosed herein. Accordingly, the specification and drawings are illustrative rather than restrictive.

Physical computer-readable storage media includes RAM, ROM, EEPROM, CD-ROM or other optical disk storage (such as CDs, DVDs, etc.), magnetic disk storage or other magnetic storage devices, solid-state disks or any other medium. They store desired program code in the form of computer-executable instructions or data structures which can be accessed by a general purpose or special purpose computer.

As used herein, the term “network” refers to one or more data links that enable the transport of electronic data between computer systems and/or modules and/or other electronic devices. When a network or another communications connection (either hardwired, wireless, or a combination of hardwired or wireless) transfers or provides information to a computer, the computer properly views the connection as a transmission medium. A general purpose or special purpose computer access transmission media that can include a network and/or data links which carry desired program code in the form of computer-executable instructions or data structures. The scope of computer-readable media includes combinations of the above, that enable the transport of electronic data between computer systems and/or modules and/or other electronic devices. The term network may include the Internet, a local area network, a wide area network, or combinations thereof. The network may include one or more networks or communication systems, such as the Internet, the telephone system, satellite networks, cable television networks, and various other private and public networks. In addition, the connections may include wired connections (such as wires, cables, fiber optic lines, etc.), wireless connections, or combinations thereof. Furthermore, although not shown, other computers, systems, devices, and networks may also be connected to the network. Network refers to any set of devices or subsystems connected by links joining (directly or indirectly) a set of terminal nodes sharing resources located on or provided by network nodes. The computers use common communication protocols over digital interconnections to communicate with each other. For example, subsystems may comprise the cloud. Cloud refers to servers that are accessed over the Internet, and the software and databases that run on those servers.

Further, upon reaching various computer system components, program code in the form of computer-executable instructions or data structures can be transferred automatically from transmission computer-readable media to physical computer-readable storage media (or vice versa). For example, computer-executable instructions or data structures received over a network or data link can be buffered in RAM within a Network Interface Module (NIC), and then eventually transferred to computer system RAM and/or to less volatile computer-readable physical storage media at a computer system. Thus, computer system components that also (or even primarily) utilize transmission media may include computer-readable physical storage media.

Computer-executable instructions comprise, for example, instructions and data which cause a general purpose computer, special purpose computer, or special purpose processing device to perform a certain function or group of functions. The computer-executable instructions may be, for example, binary, intermediate format instructions such as assembly language, or even source code. Although the subject matter herein described is in a language specific to structural features and/or methodological acts, the described features or acts described do not limit the subject matter defined in the claims. Rather, the herein described features and acts are example forms of implementing the claims.

While this specification contains many specifics, these do not construe as limitations on the scope of the disclosure or of the claims, but as descriptions of features specific to particular implementations. A single implementation may implement certain features described in this specification in the context of separate implementations. Conversely, multiple implementations separately or in any suitable sub-combination may implement various features described herein in the context of a single implementation. Moreover, although features described herein as acting in certain combinations and even initially claimed as such, one or more features from a claimed combination may in some cases be excised from the combination, and the claimed combination may be directed to a sub-combination or variation of a sub-combination.

Similarly, while operations depicted herein in the drawings in a particular order to achieve desired results, this should not be understood as requiring that such operations be performed in the particular order shown or in sequential order or that all illustrated operations be performed, to achieve desirable results. In certain circumstances, multitasking and parallel processing may be advantageous. Moreover, the separation of various system components in the implementations should not be understood as requiring such separation in all implementations, and it should be understood that the described program components and systems may be integrated together in a single software product or packaged into multiple software products.

Even though particular combinations of features are recited in the claims and/or disclosed in the specification, these combinations are not intended to limit the disclosure of possible implementations. Other implementations are within the scope of the claims. For example, the actions recited in the claims may be performed in a different order and still achieve desirable results. In fact, many of these features may be combined in ways not specifically recited in the claims and/or disclosed in the specification. Although each dependent claim may directly depend on only one claim, the disclosure of possible implementations includes each dependent claim in combination with every other claim in the claim set.

Further, a computer system including one or more processors and computer-readable media such as computer memory may practice the methods. In particular, one or more processors execute computer-executable instructions, stored in the computer memory, to perform various functions such as the acts recited in the embodiments.

Those skilled in the art will appreciate that the disclosure may be practiced in network computing environments with many types of computer system configurations including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, etc. Distributed system environments where local and remote computer systems, which are linked (either by hardwired data links, wireless data links, or by a combination of hardwired and wireless data links) through a network, both perform tasks may also practice the disclosure. In a distributed system environment, program modules may be located in both local and remote memory storage devices.

As used herein, the term “Unauthorized access” is when someone gains access to a website, program, server, service, or other system using someone else's account or other methods. For example, if someone kept guessing a password or username for an account that was not theirs until they gained access, it is considered unauthorized access.

As used herein, the term “IoT” stands for Internet of Things which describes the network of physical objects “things” or objects embedded with sensors, software, and other technologies for the purpose of connecting and exchanging data with other devices and systems over the internet.

As used herein, the term “Dashboard” is a type of interface that visualizes particular Key Performance Indicators (KPIs) for a specific goal or process. It is based on data visualization and infographics.

As used herein, a “Database” is a collection of organized information so that it can be easily accessed, managed, and updated. Computer databases typically contain aggregations of data records or files.

As used herein, the term “Data set” (or “Dataset”) is a collection of data. In the case of tabular data, a data set corresponds to one or more database tables, where every column of a table represents a particular variable, and each row corresponds to a given record of the data set in question. The data set lists values for each of the variables, such as height and weight of an object, for each member of the data set. Each value is known as a datum. Data sets can also consist of a collection of documents or files.

As used herein, a “sensor” is a device that detects and measures physical properties from the surrounding environment and converts this information into electrical or digital signals for further processing. Sensors play a crucial role in collecting data for various applications across industries. Sensors may be made of electronic, mechanical, chemical, or other engineering components. Examples include sensors to measure temperature, pressure, humidity, proximity, light, acceleration, orientation etc.

The term “infotainment system” or “in-vehicle infotainment system” (IVI) as used herein refers to a combination of vehicle systems which are used to deliver entertainment and information. In an example, the information may be delivered to the driver and the passengers of a vehicle/occupants through audio/video interfaces, control elements like touch screen displays, button panel, voice commands, and more. Some of the main components of an in-vehicle infotainment systems are integrated head-unit, heads-up display, high-end Digital Signal Processors (DSPs), and Graphics Processing Units (GPUs) to support multiple displays, operating systems, Controller Area Network (CAN), Low-Voltage Differential Signaling (LVDS), and other network protocol support (as per the requirement), connectivity modules, automotive sensors integration, digital instrument cluster, etc.

The term “environment” or “surrounding” as used herein refers to surroundings and the space in which a vehicle is navigating. It refers to dynamic surroundings in which a vehicle is navigating which includes other vehicles, obstacles, pedestrians, lane boundaries, traffic signs and signals, speed limits, potholes, snow, water logging etc.

The term “autonomous mode” as used herein refers to an operating mode which is independent and unsupervised.

The term “vehicle” as used herein refers to a thing used for transporting people or goods. Automobiles, cars, trucks, buses, etc., are examples of vehicles. Further, the vehicle may include electric vehicles (EVs), hybrid electric vehicles (HEVs) such as, without limitations, full hybrid electric vehicles (FHEVs) and mild hybrid electric vehicles (MHEVs), battery electric vehicles (BEVs), and plug-in hybrid electric vehicles (PHEVs).

The term “autonomous vehicle” also referred to as self-driving vehicle, driverless vehicle, robotic vehicle as used herein refers to a vehicle incorporating vehicular automation, that is, a vehicle that can sense its environment and move safely with little or no human input. Self-driving vehicles combine a variety of sensors to perceive their surroundings, such as thermographic cameras, Radio Detection and Ranging (RADAR), Light Detection and Ranging (LIDAR), Sound Navigation and Ranging (SONAR), Global Positioning System (GPS), odometry and inertial measurement unit. Control systems are designed for the purpose of interpreting sensor information to identify appropriate navigation paths, as well as obstacles and relevant signage.

The term “communication module” or “communication system” as used herein refers to a system which enables the information exchange between two points. The process of transmission and reception of information is called communication. The elements of communication include but are not limited to a transmitter of information, channel or medium of communication and a receiver of information.

The term “autonomous communication” as used herein comprises communication over a period with minimal supervision under different scenarios and is not solely or completely based on pre-coded scenarios or pre-coded rules or a predefined protocol. Autonomous communication, in general, happens in an independent and an unsupervised manner. In an embodiment, a communication module is enabled for autonomous communication.

The term “communication connection” or “communication network” as used herein refers to a communication link. It refers to a communication channel that connects two or more devices for the purpose of data transmission. It may refer to a physical transmission medium such as a wire, or to a logical connection over a multiplexed medium such as a radio channel in telecommunications and computer networks. A channel is used for the information transfer of, for example, a digital bit stream, from one or several senders to one or several receivers. A channel has a certain capacity for transmitting information, often measured by its bandwidth in Hertz (Hz) or its data rate in bits per second. For example, a Vehicle-to-Vehicle (V2V) communication may wirelessly exchange information about the speed, location and heading of surrounding vehicles. Similarly, a Vehicle-to-Grid (V2G) communication may exchange charge information and further transfer charge from the vehicle to the grid.

The term “communication” as used herein refers to the transmission of information and/or data from one point to another. Communication may be by means of electromagnetic waves. Communication is also a flow of information from one point, known as the source, to another, the receiver. Communication comprises one of the following: transmitting data, instructions, information or a combination of data, instructions, and information. Communication happens between any two communication systems or communicating units. The term communication, herein, includes systems that combine other more specific types of communication, such as: V2I (Vehicle-to-Infrastructure), V2N (Vehicle-to-Network), V2V (Vehicle-to-Vehicle), V2P (Vehicle-to-Pedestrian), V2D (Vehicle-to-Device), V2G (Vehicle-to-Grid), and Vehicle-to-Everything (V2X) communication.

The term “Vehicle-to-Vehicle (V2V) communication” refers to the technology that allows vehicles to broadcast and receive messages. The messages may be omni-directional messages, creating a 360-degree “awareness” of other vehicles in proximity. Vehicles may be equipped with appropriate software (or safety applications) that can use the messages from surrounding vehicles to determine potential crash threats as they develop.

The term “Vehicle-to-Everything (V2X) communication” as used herein refers to transmission of information from a vehicle to any entity that may affect the vehicle, and vice versa. Depending on the underlying technology employed, there are two types of V2X communication technologies: cellular networks and other technologies that support direct device-to-device communication (such as Dedicated Short-Range Communication (DSRC), Port Community System (PCS), Bluetooth®, Wi-Fi®, etc.).

The term “protocol” as used herein refers to a procedure required to initiate and maintain communication; a formal set of conventions governing the format and relative timing of message exchange between two communications terminals; a set of conventions that govern the interactions of processes, devices, and other components within a system; a set of signaling rules used to convey information or commands between boards connected to the bus; a set of signaling rules used to convey information between agents; a set of semantic and syntactic rules that determine the behavior of entities that interact; a set of rules and formats (semantic and syntactic) that determines the communication behavior of simulation applications; a set of conventions or rules that govern the interactions of processes or applications between communications terminals; a formal set of conventions governing the format and relative timing of message exchange between communications terminals; a set of semantic and syntactic rules that determine the behavior of functional units in achieving meaningful communication; a set of semantic and syntactic rules for exchanging information.

The term “communication protocol” as used herein refers to standardized communication between any two systems. An example of a communication protocol is the DSRC protocol. The DSRC protocol uses a specific frequency band (e.g., 5.9 GHz (Gigahertz)) and specific message formats (such as the Basic Safety Message, Signal Phase and Timing, and Roadside Alert) to enable communications between vehicles and infrastructure components, such as traffic signals and roadside sensors. DSRC is a standardized protocol, and its specifications are maintained by various organizations, including the Institute of Electrical and Electronics Engineers (IEEE) and Society of Automotive Engineers (SAE) International. In some embodiments, the communication protocol between a charging point and a vehicle may include an international standards organization (ISO) 15118-2 protocol

The term “bidirectional communication” as used herein refers to an exchange of data between two components. In an example, the first component can be a vehicle and the second component can be an infrastructure that is enabled by a system of hardware, software, and firmware. In an example, the second component can be an energy source capable of charging a vehicle battery and accepting charge from the vehicle battery.

The term “in communication with” as used herein, refers to any coupling, connection, or interaction using signals to exchange information, message, instruction, command, and/or data, using any system, hardware, software, protocol, or format regardless of whether the exchange occurs wirelessly or over a wired connection.

The term “electronic control unit” (ECU), also known as an “electronic control module”, is usually a module that controls one or more subsystems. Herein, an ECU may be installed in a vehicle or other motor vehicle. It may refer to many ECUs, and can include but not limited to, Engine Control Module (ECM), Powertrain Control Module (PCM), Transmission Control Module (TCM), Brake Control Module (BCM) or Electronic Brake Control Module (EBCM), Central Control Module (CCM), Central Timing Module (CTM), General Electronic Module (GEM), Body Control Module (BCM), and Suspension Control Module (SCM). ECUs together are sometimes referred to collectively as the vehicles' computer or vehicles' central computer and may include separate computers. In an example, the electronic control unit can be an embedded system in automotive electronics. In another example, the electronic control unit is wirelessly coupled with automotive electronics.

The terms “non-transitory computer-readable medium” and “computer-readable medium” include a single medium or multiple media such as a centralized or distributed database, and/or associated caches and servers that store one or more sets of instructions. Further, the terms “non-transitory computer-readable medium” and “computer-readable medium” include any tangible medium that is capable of storing, encoding, or carrying a set of instructions for execution by a processor that, for example, when executed, cause a system to perform any one or more of the methods or operations disclosed herein. As used herein, the term “computer-readable medium” is expressly defined to include any type of computer-readable storage device and/or storage disk and to exclude propagating signals.

The term “Vehicle Data bus” as used herein represents the interface to the vehicle data bus (e.g., Controller Area Network (CAN), Local Interconnect Network (LIN), Ethernet/IP, FlexRay, and Media Oriented Systems Transport (MOST)) that may enable communication between the Vehicle on-board equipment (OBE) and other vehicle systems to support connected vehicle applications.

The term, “handshaking” refers to an exchange of predetermined signals between agents connected by a communications channel to assure each that it is connected to the other (and not to an imposter). This may also include the use of passwords and codes by an operator. Handshaking signals are transmitted back and forth over a communications network to establish a valid connection between two stations. A hardware handshake uses dedicated wires such as the request-to-send (RTS) and clear-to-send (CTS) lines in a Recommended Standard 232 (RS-232) serial transmission. A software handshake sends codes such as “synchronize” (SYN) and “acknowledge” (ACK) in a Transmission Control Protocol/Internet Protocol (TCP/IP) transmission.

The term “computer vision module” or “computer vision system” allows the vehicle to “see” and interpret the world around it. This system uses a combination of cameras, sensors, and other technologies such as Radio Detection and Ranging (RADAR), Light Detection and Ranging (LIDAR), Sound Navigation and Ranging (SONAR), Global Positioning System (GPS), and Machine learning algorithms, etc. to collect visual data about the vehicle's surroundings and to analyze that data in real-time. The computer vision system is designed to perform a range of tasks, including object detection, lane detection, and pedestrian recognition. It uses deep learning algorithms and other machine learning techniques to analyze visual data and make decisions about how to control the vehicle. For example, the computer vision system may use object detection algorithms to identify other vehicles, pedestrians, and obstacles in the vehicle's path. It can then use this information to calculate the vehicle's speed and direction, adjust its trajectory to avoid collisions, and apply the brakes or accelerate as needed. It allows the vehicle to navigate safely and efficiently in a variety of driving conditions.

As used herein, the term “driver” refers to such an occupant, even when that occupant is not actually driving the vehicle but is situated in the vehicle so as to be able to take over control and function as the driver of the vehicle when the vehicle control system hands over control to the occupant or driver or when the vehicle control system is not operating in an autonomous or semi-autonomous mode. The driver is also referred to as an operator of the vehicle.

The term “application server” refers to a server that hosts applications or software that delivers a business application through a communication protocol. An application server framework is a service layer model. It includes software components available to a software developer through an application programming interface. It is system software that resides between the operating system (OS) on one side, the external resources such as a database management system (DBMS), communications and Internet services on another side, and the users' applications on the third side.

The term “cyber security” as used herein refers to application of technologies, processes, and controls to protect systems, networks, programs, devices, and data from cyber-attacks.

The term “cyber security module” as used herein refers to a module comprising application of technologies, processes, and controls to protect systems, networks, programs, devices and data from cyber-attacks and threats. It aims to reduce the risk of cyber-attacks and protect against the unauthorized exploitation of systems, networks, and technologies. It includes, but is not limited to, critical infrastructure security, application security, network security, cloud security, Internet of Things (IoT) security.

The term “encrypt” used herein refers to securing digital data using one or more mathematical techniques, along with a password or “key” used to decrypt the information. It refers to converting information or data into a code, especially to prevent unauthorized access. It may also refer to concealing information or data by converting it into a code. It may also be referred to as cipher, code, encipher, encode. A simple example is representing alphabets with numbers—say, ‘A’ is ‘01’, ‘B’ is ‘02’, and so on. For example, a message like “HELLO” is encrypted as “0805121215,” and this value is transmitted over the network to the recipient(s).

The term “decrypt” used herein refers to the process of converting an encrypted message back to its original format. It is generally a reverse process of encryption. It decodes the encrypted information so that only an authorized user can decrypt the data because decryption requires a secret key or password. This term could be used to describe a method of unencrypting the data manually or unencrypting the data using the proper codes or keys.

The term “cyber security threat” used herein refers to any possible malicious attack that seeks to unlawfully access data, disrupt digital operations, or damage information. A malicious act includes but is not limited to damaging data, stealing data, or disrupting digital life in general. Cyber threats include, but are not limited to, malware, spyware, phishing attacks, ransomware, zero-day exploits, trojans, advanced persistent threats, wiper attacks, data manipulation, data destruction, rogue software, malvertising, unpatched software, computer viruses, man-in-the-middle attacks, data breaches, Denial of Service (DoS) attacks, and other attack vectors.

The term “hash value” used herein can be thought of as fingerprints for files. The contents of a file are processed through a cryptographic algorithm, and a unique numerical value, the hash value, is produced that identifies the contents of the file. If the contents are modified in any way, the value of the hash changes significantly. Example algorithms used to produce hash values: the Message Digest-5 (MD5) algorithm and Secure Hash Algorithm-1 (SHA1).

The term “integrity check” as used herein refers to the checking for accuracy and consistency of system related files, data, etc. It may be performed using checking tools that can detect whether any critical system files have been changed, thus enabling the system administrator to look for unauthorized alteration of the system. For example, data integrity corresponds to the quality of data in the databases and to the level by which users examine data quality, integrity, and reliability. Data integrity checks verify that the data in the database is accurate, and functions as expected within a given application.

The term “alarm” as used herein refers to a trigger when a component in a system or the system fails or does not perform as expected. The system may enter an alarm state when a certain event occurs. An alarm indication signal is a visual signal to indicate the alarm state. For example, when a cyber security threat is detected, a system administrator may be alerted via sound alarm, a message, a glowing LED, a pop-up window, etc. Alarm indication signal may be reported downstream from a detecting device, to prevent adverse situations or cascading effects.

As used herein, the term “cryptographic protocol” is also known as security protocol or encryption protocol. It is an abstract or concrete protocol that performs a security-related function and applies cryptographic methods often as sequences of cryptographic primitives. A protocol describes how the algorithms should be used. A sufficiently detailed protocol includes details about data structures and representations, at which point it can be used to implement multiple, interoperable versions of a program. Cryptographic protocols are widely used for secure application-level data transport. A cryptographic protocol usually incorporates at least some of these aspects: key agreement or establishment, entity authentication, symmetric encryption, and message authentication material construction, secured application-level data transport, non-repudiation methods, secret sharing methods, and secure multi-party computation. Hashing algorithms may be used to verify the integrity of data. Secure Socket Layer (SSL) and Transport Layer Security (TLS), the successor to SSL, are cryptographic protocols that may be used by networking switches to secure data communications over a network.

The embodiments described herein can be directed to one or more of a system, a method, an apparatus, and/or a computer program product at any possible technical detail level of integration. The computer program product can include a computer-readable storage medium (or media) having computer-readable program instructions thereon for causing a processor to carry out aspects of the one or more embodiments described herein.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function(s). In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It is to be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

As used in this application, the terms “component,” “system,” “platform,” “interface,” and/or the like, can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer-readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

The embodiments described herein include mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The term “vehicle system” or “system of a vehicle” or “system associated with a vehicle” as used herein refers to the vehicle comprising the system described in the current application. The system may be integrated and is a part of the vehicle, for example, a system executing a method on a processor storing instructions in a non-transitory memory of the computer system of the vehicle. The system may be external, but the instructions or method is executed through the vehicle, for example the method being in a cloud but is accessed and executed by the vehicle. The system may be designed for a specific purpose to carry out a certain function or task, for example, transmitting a specific message to a user device. The designed system comprising instructions may also be using existing systems present on the vehicle, for example, a communication system of the vehicle.

The term “charging point” as used herein refers to an energy source supplying power for the vehicle to function. In some embodiments, the charging point may be connected to a grid. The charging point may supply energy from the grid to the vehicle. In some embodiments, the charging point may enable transferring power from the vehicle to the grid. In some embodiments, the charging point may comprise a charge storage device for storing charge in a large quantity, to then be discharged to the vehicle when needed. In some embodiments, the charging point may include at least one of a wall box, a charging station, an electric vehicle supply equipment (EVSE), and a charging pool, wherein the charging pool may comprise a plurality of charging stations providing different types of charging connections.

The term “charging point system” or “system of a charging point” or “system associated with a charging point” as used herein refers to the charging point comprising the system described in the current application. The system may be integrated and is a part of the charging point, for example, a system executing a method on a processor storing instructions in a non-transitory memory of the computer system of the charging point. The system may be external, but the instructions or method is executed through the charging point, for example the method being in a cloud but is accessed and executed by the charging point. The system may be designed for a specific purpose to carry out a certain function or task, for example, transmitting a specific message to a user device. The designed system comprising instructions may also be using existing systems present on the charging point, for example, a communication system of the charging point.

The term “battery” as used herein refers to a battery system in the vehicle, wherein the battery system may be used for starting the vehicle or may be used for operating the vehicle. The battery system may also be used to enable the vehicle to run.

The term “charge” or “battery charge” or “charge level” or “state of charge (SoC)” as used herein refers to the amount of energy in the battery relative to a capacity of the battery. Charge in general is expressed as a percentage, wherein 100% indicates a fully charged battery and 0% indicates a completely discharged battery. Further, “charging” or “battery charging” or “charge the battery” refers to the process of replenishing the energy stored in the battery by applying an electric current to the battery. In some embodiments, the battery may be connected to a charger and the charging process converts the electrical energy from the charger into chemical energy in the battery.

The term “discharge” or “battery discharge” as used herein refers to the amount of energy supplied by the battery to a load such as, without limitations, a device or another battery or an energy source (e.g., a grid). Further, “discharging” or “battery discharging” or “discharge the battery” refers to the process of extracting the energy stored in the battery. The discharging process converts the chemical energy from the battery into electrical energy that may be supplied to any load connected to the battery.

The term “threshold charge level” or “threshold level” or “threshold” or threshold value” as used herein refers to a minimum battery charge level required by the vehicle for its operation.

The term “monitoring” as used herein refers to systematic observation and assessment of a system, process, or environment in real-time or near real-time. It involves the regular collection, analysis, and interpretation of data using various sensors. Monitoring may be continuous or adaptive. In some embodiments, monitoring may be performed on the status of the battery, for example, a charge level of the battery.

The term “supply power” or “power supply” as used herein refers to the power associated with at least one of a charging operation (i.e. from grid-to-vehicle) or a discharging operation (i.e., from vehicle-to-grid).

The term “grid codes” as used herein refers to technical requirements, regulations, and specifications that need to be met by a facility connected to a public electric grid to ensure safe, secure and economic functioning of the electrical system of a country. In some embodiments, the facility comprises a power generation plant, a consumer, or a charging point. In some embodiments, the grid codes may vary based on a particular location in a country. In some embodiments, the grid codes may be updated based on a time period, for e.g., monthly once, quarterly once, half yearly once, or annually.

The term “user” as used herein refers to any individual who is a driver or an owner of the vehicle. Broadly, it may encompass any individual having the possession of the vehicle.

Business Problem: With a growing need for green transport the use of battery-operated vehicles is increasing day by day. The increased usage of battery-operated vehicles results in an increased number of charging points so that the vehicles can charge their battery frequently. Other than charging their battery, vehicles may also discharge back to the grid to provide an excessive charge stored in the battery back to the grid for monetary benefits. Vehicles charge and discharge from/to the grid or any power source through the charging point.

Business Solution: Communicating detailed information related to supply power and grid codes enables efficient charging and discharging operation.

Technical Problem: The vehicle communicates with the charging point using an international standards organization (ISO) 15118-2 protocol. Currently in the ISO 15118-2 standard, the vehicle does not send any information in a message from the vehicle to the charging point. Further, the charging point only sends information associated with the value of a supply power, there is no communication related to a mode of operation (i.e., charging or discharging), a set point associated with the mode of operation, or a maximum limit associated with the supply power. The lack of information related to the mode of operation, the set point, or maximum limit may result in the blowing of the fuse if the vehicle deviates from the requested current set point and changes the mode of operation from “charging to discharging” or “discharging to charging” without the charging point requesting it. Also, for charging or discharging the vehicle requires grid codes to comply with certain regulations at a particular place.

Technical solution: In view of the above, there is a need to send more information from the charging point to the vehicle using the ISO 15118-2 protocol. Further, there is also a need to communicate grid codes from the charging point to the vehicle. In some embodiments, the information from the charging point to the vehicle may comprise at least one of maximum discharge limit, maximum charge limit, set point, and phase information.

In one aspect the present disclosure relates to encoding a message between the charging point and the vehicle to include at least one of a maximum value of the supply power or a maximum value of current, a direction associated with the supply power or the current, a charging or discharging operation, a phase information of the supply power or current, and a set point and a maximum limit associated with the supply power or current.

In an embodiment, the charging point may include an electric vehicle supply equipment (EVSE) and the vehicle may include an electric vehicle (EV). During the communication between the EVSE and the EV using ISO 15118-2, the EVSE sends a ChargeStatusRes signal. ChargeStatusRes signal is based on ISO 15118-2 standard and is used for communicating the supply power level provided by the EVSE to the EV. The EVSE encodes at least 16-bits of the ChargeStatusRes signal such that at least bits 0-9 indicate a value of the supply power, at least bit 10 indicates a sign or a direction of the supply power, at least bit 11 indicates a charge or discharge operation to be performed, at least bit 12 indicates information associated with phase 1 of the supply power, at least bit 13 indicates information associated with phase 2 of the supply power, at least bit 14 indicates information associated with phase 3 of the supply power, and at least bit 15 indicates maximum limit or a set point associated with at least one of phase 1, phase 2, or phase 3 of the supply power for at least one of a charging operation or a discharging operation. The EVSE encodes at least 16-bits of the ChargeStatusRes signal to provide information to control each phase of the supply power either individually or collectively. In some embodiments, if all the three phases have the same set point and maximum limit, the EVSE may encode a single message to include the phase information.

In some embodiments, if each phase has a different set point and maximum limit, the EVSE may encode different messages to convey different phase information. The EVSE may send the set point in either one, two, or three messages and then send a maximum limit associated with discharging or charging in either one, two, or three messages. For example, if the current is the same in all the three phases during a charging operation the EVSE may encode a single message to convey the set point associated with the charging operation and a single message to convey the maximum limit associated with the charging operation. Similarly, if the current is same in all the three phases during a discharging operation the EVSE may encode a single message to convey the set point associated with the discharging operation and a single message to convey the maximum limit associated with the discharging operation. Further, if one phase has a different current than the other two phases then EVSE may encode two messages to convey the set point and two messages to convey the maximum limit, wherein the set point and maximum limit are associated with at least one of the charging or discharging operations, one for the unique phase and one message for the other two phases. If all the three phases have different current, then the EVSE may encode three different messages to convey set point and three different messages to convey maximum limit, i.e., if there are different set points for all the three phases for charging, different maximum limit for all three phases for charging, different set points for all the three phases for discharging, different maximum limit for all three phases for discharging a total of 12 messages are sent by the EVSE to the EV. In some embodiments, the EV sends an acknowledgement message for each message from the EVSE.

For example, if a vehicle wants to charge, the vehicle may connect to the EVSE. The vehicle may first receive a set point message from the EVSE indicating how much current the EVSE wants the vehicle to draw. The vehicle may then send an acknowledgement message for the received set point. The vehicle may further receive a message from the EVSE indicating a maximum limit for charge. In some embodiments, the maximum limit may be the same as the set point. In some embodiments, the maximum limit may be higher or lower than the set point. The vehicle may then send an acknowledgement for the maximum limit. In some embodiments, the EVSE may send the maximum limit for discharge. The vehicle may then send an acknowledgement for the maximum limit. The messaging between the EVSE and the vehicle is looped repeatedly until the session is complete.

In some embodiments, the set point and the maximum limit are determined based on grid codes. In general, grid codes define a set of guidelines to be followed by an entity being a part of an electrical system of a country. According to an embodiment, the vehicle receives a grid code from a centralized server such as a cloud server to discharge to the grid. However, in some situations the vehicle may not be connected to a network and may not be able to receive the grid codes from the centralized server or the cloud server. In such conditions, the vehicle may find it difficult to discharge to the grid without the knowledge of grid codes.

In another aspect the present disclosure discloses the use of the charging point identity to provide grid codes to the vehicle. In some embodiments, the charging point may communicate the charging point identity to the electric vehicle based on the ISO 15118-2 protocol. The charging point identity, based on the ISO 15118-2 protocol, comprises a country code, and the vehicle may obtain the grid code based on the country code.

In some embodiments, during the start of communication between the charging point, for example, between the EVSE and the vehicle, the EVSE sends the EVSE ID to the vehicle. The EVSE ID based on the ISO-15118-2 protocol comprises <EVSE ID>=<country code><s><EVSE Operator ID><s><ID type><s><Charging Site ID><s><Power Outlet ID ><s><Check digit>. In some embodiments, the charging site ID comprises a location owner identity, the ID type comprises an identity related to the type of charging point and the power outlet ID comprises a charging point identity. The vehicle, upon looking at the country code in the EVSE ID, may decide what grid code parameters to use. If there are multiple grid codes in a country, the vehicle may look at the check digit along with the country code to determine the grid codes. In some embodiments, the vehicle may include a lookup table comprising the grid codes, country code, and check digit. According to an embodiment, the check digit may be based on at least one of the location owner identity, identity related to the type of charging point, and the charging point identity. In some embodiments, the vehicle may include a lookup table comprising the grid codes, country code, and charging point identity and when there are multiple grid codes in a country, the vehicle may look at the charging point identity along with the country code to determine the grid codes. In some embodiments, the vehicle may obtain the lookup table from the EVSE. In some embodiments, the vehicle may obtain the lookup table from the centralized server or the cloud server.

In another aspect, the present disclosure discloses establishing a connection between the charging point and the vehicle and transmitting a first message associated with the grid codes and a second message associated with the supply power information, wherein the grid codes in the first message enables the vehicle to charge and discharge based on the supply power information in the second message.

In an aspect the present disclosure relates to a system comprising: a memory, storing program instructions; and a processor coupled to the memory and executing the program instructions stored in the memory, wherein the program instructions, when executed by the processor, causes the processor to: generate a message comprising a value of supply power for a vehicle along with at least one of a first indicator associated with a direction associated with the supply power, a second indicator associated with at least one of charging and discharging operation, a third indicator associated with a phase information of the supply power, and a fourth indicator associated with at least one of a set point and a maximum limit associated with the supply power; encode the generated message; and transmit the encoded message to the vehicle to perform at least one of a charging operation and a discharging operation based on information in the encoded message.

In another aspect the present disclosure relates to a method comprising: generating a message comprising a value of supply power for a vehicle along with at least one of a first indicator associated with a direction of the supply power, a second indicator associated with at least one of charging and discharging operation, a third indicator associated with a phase information of the supply power, and a fourth indicator associated with at least one of a set point and a maximum current limit associated with the supply power; encoding the generated message; and transmitting the encoded message to the vehicle to perform at least one of a charging operation and a discharging operation based on information in the encoded message.

In yet another aspect the present disclosure relates to a non-transitory computer-readable medium having stored thereon instructions executable by a processor to perform operations comprising: generating a message comprising a value of supply power for a vehicle along with at least one of a first indicator associated with a direction of the supply power, a second indicator associated with at least one of charging and discharging operation, a third indicator associated with a phase information of the supply power, and a fourth indicator associated with at least one of a set point and a maximum current limit associated with the supply power; encoding the generated message; and transmitting the encoded message to the vehicle to perform at least one of a charging operation and a discharging operation based on information in the encoded message.

In yet another aspect the present disclosure relates to a method comprising receiving an encoded message from a charging point, wherein the encoded message comprises a value of supply power for a vehicle along with at least one of a first indicator associated with a direction of the supply power, a second indicator associated with at least one of charging and discharging operation, a third indicator associated with a phase information of the supply power, and a fourth indicator associated with at least one of a set point and a maximum limit associated with the supply power; decoding the encoded message from the charging point to obtain one or more information from the encoded message; and performing at least one of a charging operation and a discharging operation based on the obtained information.

In yet another aspect the present disclosure relates to a system comprising: a battery monitoring unit; and a processor communicatively coupled to the battery monitoring unit, wherein the battery monitoring unit is operable to: determine a charge level in a vehicle battery and communicate the determined charge level to the processor, wherein the processor is operable to: determine, based on the charge level, to perform at least one of charging the vehicle battery and discharging the vehicle battery; communicate to a charging point to perform charging based on the charge level below a threshold; receive from the charging point an encoded message comprising a value of supply power for a vehicle along with at least one of a first indicator associated with a direction of the supply power, a second indicator associated with at least one of charging and discharging operation, a third indicator associated with a phase information of the supply power, and a fourth indicator associated with a maximum limit associated with the supply power; and charge the vehicle battery based on information in the encoded message.

In one aspect the present disclosure relates to a system comprising: a memory storing program instructions; and a processor coupled to the memory and executing the program instructions stored in the memory, wherein the program instructions, when executed by the processor, cause the processor to: generate a message comprising at least one of a country code, a location owner identity, identity related to a type of charging point, and a charging point identity along with a check digit, wherein the generated message provides one or more grid codes; and transmit the generated message to a vehicle.

In another aspect the present disclosure relates to a method comprising: generating a message comprising at least one of a country code, a location owner identity, identity related to a type of charging point, and a charge point identity along with a check digit, wherein the generated message provides one or more grid codes; and transmitting the generated message to a vehicle.

In yet another aspect the present disclosure relates to a non-transitory computer-readable medium having stored thereon instructions executable by a processor to perform operations comprising: generating a message comprising at least one of a country code, a location owner identity, identity related to a type of charging point, and a charge point identity along with a check digit, wherein the generated message provides one or more grid codes; and transmitting the generated message to a vehicle.

In yet another aspect the present disclosure relates to a system comprising: a memory storing program instructions; and a processor coupled to the memory and executing the program instructions stored in the memory, wherein the program instructions, when executed by the processor, causes the processor to: receive a message from a charging point, wherein the message comprises at least one of a country code, a location owner identity, identity related to a type of charging point, and a charge point identity along with a check digit; and decode the received message to determine one or more grid codes associated with a particular location.

In yet another aspect the present disclosure relates to a system comprising: a memory storing program instructions and a processor coupled to the memory and executing the program instructions stored in the memory, wherein the program instructions, when executed by the processor, causes the processor to generate a first message comprising at least one of a country code, a location owner identity, identity related to a type of charging point, and a charge point identity along with a check digit, wherein the generated message provides one or more grid codes; generate a second message comprising a value of supply power for a vehicle along with at least one of a first indicator associated with a direction associated with the supply power, a second indicator associated with at least one of charging and discharging operation, a third indicator associated with a phase information of the supply power, and a fourth indicator associated with at least one of a set point and a maximum limit associated with the supply power; and transmit the first message and the second message to the vehicle to perform at least one of a charging operation and a discharging operation based on information in the first message and the second message.

In yet another aspect the present disclosure relates to a method comprising: generating a first message comprising at least one of a country code, a location owner identity, identity related to a type of charging point, and a charge point identity along with a check digit, wherein the generated first message provides one or more grid codes; and generating a second message comprising a value of supply power for a vehicle along with at least one of a first indicator associated with a direction of the supply power, a second indicator associated with at least one of charging and discharging operation, a third indicator associated with a phase information of the supply power, and a fourth indicator associated with at least one of a set point and a maximum limit associated with the supply power; and transmitting the first message and the second message to the vehicle to perform at least one of a charging operation and a discharging operation based on information in the first message and the second message.

In yet another aspect the present disclosure relates to a non-transitory computer-readable medium having stored thereon instructions executable by a processor to perform operations comprising: generating a first message comprising at least one of a country code, a location owner identity, identity related to a type of charging point, and a charge point identity along with a check digit, wherein the generated first message provides one or more grid codes; and generating a second message comprising a value of supply power for a vehicle along with at least one of a first indicator associated with a direction of the supply power, a second indicator associated with at least one of charging and discharging operation, a third indicator associated with a phase information of the supply power, and a fourth indicator associated with at least one of a set point and a maximum limit associated with the supply power; and transmitting the first message and the second message to the vehicle to perform at least one of a charging operation and a discharging operation based on information in the first message and the second message.

Technical Result: Detailed communication of the phase information, maximum and minimum charging discharging limits, set point limits, and grid codes between the charging point and the vehicle enables proper charging and discharging operation without any damage to the vehicle or the charging point.

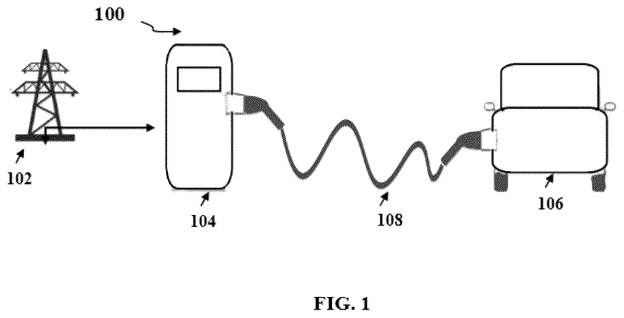

Technical details specific to the technical solution: FIG. 1 illustrates a network diagram for communication between a charging point and a vehicle according to an embodiment.

Referring to FIG. 1, network 100 comprises vehicle 106 connected through charging cable 108 to charging point 104, wherein charging point 104 is connected to grid 102. The charging point enables vehicle 106 to charge/discharge from/to the grid. Charging point 104 may comprise at least one of a charging station, an EVSE, a charge pool, and a wall box. FIG. 1 illustrates charging cable 108 or a wired connection between the charging point and the vehicle. However, it would be appreciated by the person skilled in the art that the connection between the charging point and the vehicle may include a wireless connection, and the vehicle may wirelessly charge from the charging point. In some embodiments, the communication between the charging point and the vehicle is based on ISO 15118-2 protocol. In some embodiments, the charging point shares an identity associated with the charging point to the vehicle based on the vehicle establishing a connection with the charging point. In some embodiments, the identity associated with the charging point provides grid codes associated with a particular location the vehicle is currently located. Grid codes are a set of legal regulations required to be adhered by the vehicle to charge and discharge from and to the grid. In some embodiments, the charging point comprises a system configured to provide a first message comprising the grid codes to the vehicle and a second message comprising phase information associated with the supply power to the vehicle. Further, the system is also configured to encode the second message for conveying the information associated with the supply power. In some embodiments, the vehicle comprises a system for determining grid codes from the first message and decoding the encoded second message to perform charging or discharging based at least on the information in the encoded second message.

It would be appreciated by a person ordinarily skilled in the art that network 100 is not restricted to only the components shown in FIG. 1 and may include various other components. Further, the system for providing the first and second messages and encoding may be any system associated with the charging point. In some embodiments, the system may be placed within the charging point. In some embodiments, the system may be a centralized system or a cloud server communicatively coupled with the charging point.

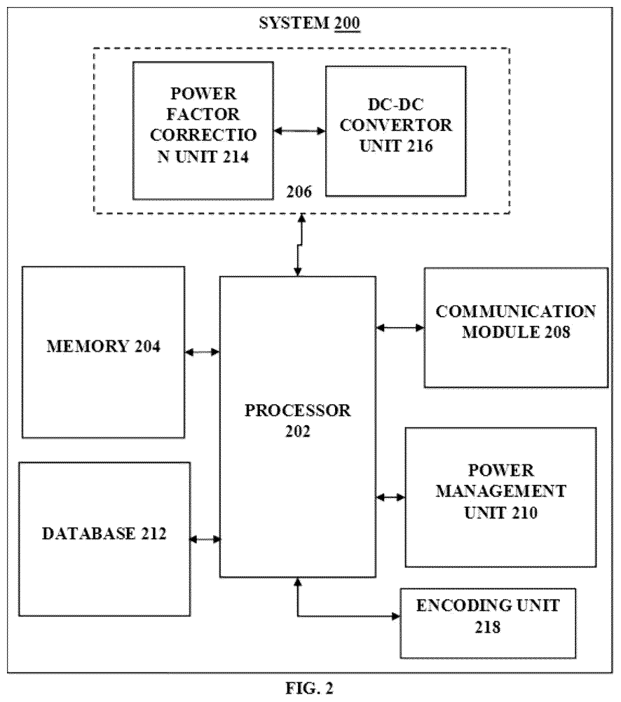

FIG. 2 illustrates a block diagram of system 200 associated with a charging point according to an embodiment.

In some embodiments, system 200 is a component of the charging point and configured to generate at least one of a message comprising the grid code and information associated with the supply power. In some embodiments, system 200 enables communication between the charging point and the vehicle.

System 200 comprises processor 202, memory 204, communication module 208, power management unit 210, database 212, power module 206 comprising power factor correction unit 214, direct current to direct current (DC-DC) convertor unit 216, and encoding unit 218.

Referring to FIG. 2, processor 202 may be a high-performance, multi-core CPU or system-on-chip (SoC) solution to process vast amounts of data. In some embodiments, processor 202 receives inputs from power module 206 and power management unit 210 to generate a first message for providing grid codes and a second message for providing information associated with the supply power. In some embodiments, processor 202 encodes the information associated with the supply power using encoding unit 218. Processor 202 encodes the information in the ISO 15118-2 protocol format. Processor 202 may comprise Graphics Processing Units (GPUs). GPUs are utilized for their ability to accelerate tasks like image and sensor data processing. Some vehicles may incorporate Field-Programmable Gate Arrays (FPGAs) to efficiently perform specialized computations, while others may leverage Application Specific Integrated Circuits (ASICs) for optimized functions. The choice of processor depends on factors such as the vehicle's level of autonomy, processing requirements, power consumption, and thermal considerations. Processors, also known as central processing units (CPUs), are the heart and brain of any computer or electronic device capable of executing instructions. Processor or processors' function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instruction. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze sensor data, determine conditions associated with the vehicle and a user of the vehicle, interpret the environment, and help in decision making. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. Processor 202 interacts and exchanges data with one or more of the other components or modules of the system, for example, memory 204, communication module 208, power management unit 210, power module 206, database 212, and encoding unit 218.

In some embodiments, the charging point comprises power module 206, wherein power module 206 serves as an interface between grid or an energy source providing alternating current (AC) and the vehicle. Power module 206 comprises power factor correction unit 214 and DC-DC converter unit 216. Power factor correction unit 214 serves to lower reactive power, minimize line losses, and maximize the usage of the electrical infrastructure. DC-DC converter unit 216 converts DC from one level to another level to enable charging a battery of the vehicle. Power management unit 210 comprises a voltage regulator, an AC-DC/DC-DC controller, and a protection unit. In some embodiments, power management unit 210 regulates the power required by various components of system 200.

Referring to FIG. 2, memory 204 may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high-speed operation and low power consumption. In an embodiment, the memory may be a cloud-based memory. In another embodiment, the memory may be a local memory. In another embodiment, it may be a combination of local and cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, cloud-based memory relies on remote servers and services provided by third-party cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and cloud-based memory allows for flexible and efficient data management tailored to different needs of the system.

Referring to FIG. 2, communication module 208 facilitates communication between different modules within system 200, communication between the charging point and vehicles, other devices, and other infrastructure components or energy sources, for example, grid, etc.

Referring to FIG. 2, in some embodiments, database 212 may store data associated with power management unit 210, power module 206, and encoding unit 218. In some embodiments, database 212 may be locally present in system 200 or may be present in a server associated with a manufacturer of the charging point, a server associated with a service provider of the charging point, or in a cloud server. Processor 202 may fetch the data from the database to provide a lookup table comprising at least one of a country code, check digit, and grid codes to the vehicle. Further, database 212 may include the bit positions related to encoding the supply power information. Further, database 212 may also store a set point and a maximum limit associated with charging and discharging operation.

Referring to FIG. 2, communication module 208, power management unit 210, and power module 206 are coupled to processor 202. Communication module 208 is operable to communicate with vehicles charging from the charging point to provide messages comprising at least one of grid codes and information associated with the supply power. In some embodiments, the communication module enables ISO 15118-2 protocol based communication between the charging point and the vehicle connected to the charging point.

In some embodiments, encoding unit 218 is communicatively coupled to processor 202 and performs encoding. In some embodiments, encoding unit 218 may be a part of processor 202.

In some embodiments, system 200 is a component of the charging point. In some embodiments, processor 202 is configured to detect the vehicle connected to the charging point for performing at least one of charging and discharging. Upon detecting the connection of the vehicle, the processor is configured to generate a message comprising at least one of a country code, a location owner identity, identity related to a type of charging point, and a charging point identity along with a check digit, wherein the generated message provides one or more grid codes; and transmit the generated message to the vehicle through the communication module.

In some embodiments, the charging point comprises the EVSE, and the generated message comprises an electric vehicle supply equipment identity (EVSE ID). In some embodiments, the EVSE ID comprises at least seven characters for example, two characters for Country Code, three characters for EVSE Operator ID, one character for ID Type, one character for Power Outlet ID. In some embodiments, a custom encoding scheme comprising at least 40-bits may be used to encode the EVSE ID and a check digit may be affixed to the EVSE ID. In some embodiments, the check digit may be prefixed to the EVSE ID. In some embodiments, the check digit may be suffixed to the EVSE ID. In an embodiment, the check digit may be encoded using at least 8-bits.

In some embodiments, the EVSE ID comprises at most thirty seven characters, for example, two characters for Country Code, three characters for EVSE Operator ID, one character for ID Type, and thirty one characters for Power Outlet ID. A custom encoding scheme may be used to encode the EVSE ID and the check digit may be appended to the encoded EVSE ID.

In an embodiment, the EVSE ID comprises one or more bits associated with the country code. In an embodiment, the EVSE ID comprises one or more bits associated with the location owner identity. In an embodiment, the EVSE ID comprises one or more bits associated with the identity related to a type of charging point. In an embodiment, the EVSE ID comprises one or more bits associated with the charge point identity. In an embodiment, the EVSE ID comprises one or more bits associated with the check digit.

In some embodiments, the 7 characters of the EVSE ID may be encoded using one or more encoding schemes such as but not limited to custom 6-bit Encoding, Huffman coding, and Custom compression.

In some embodiments, the country code comprises at least a two-character country code, wherein at least the first two characters of the EVSE ID provide the country code. In some embodiments, for a 40-bit EVSE ID at least 16-bits of the 40-bits are encoded to provide the country code.

In some embodiments, the EVSE ID may comprise 40-bits and the location owner identity may comprise at least three alpha numeric characters associated with at least one of a location owner and an EVSE operator, wherein at least 8-bits of the 40-bits are encoded to provide the location owner identity.

In some embodiments, the identity related to a type of charging point comprises a single character associated with at least one of an electric vehicle supply equipment (EVSE), a charging station, and a charge pool, wherein at least 8-bits of the 40-bits are encoded to provide the identity related to the type of charging point. In some embodiments, a value of ‘E’ associated with the single character represents the EVSE. In some embodiments, a value of ‘S’ associated with the single character represents the charging station. In some embodiments, a value of ‘P’ associated with the single character represents the charge pool.

In some embodiments, the charging point identity comprises at least 1 and at most 30 alpha numeric characters, wherein at least 8-bits of the 40-bits are encoded to provide the charging point identity.

In some embodiments, the use of a check digit provides selection of the correct grid code associated with a particular location in a country with multiple grid codes. In some embodiments, the check digit may be encoded using at least 8-bits and may be appended to the EVSE ID.

In some embodiments, the selection of correct grid codes associated with a particular location in the country may be based on one or more combinations of location owner identity, identity related to the charging point, and charging point identity.

In some embodiments, processor 202 may be further configured to create a lookup table comprising the one or more grid codes associated with at least one of the country code and the check digit in the generated message; and transmit the created lookup table to the vehicle. In some embodiments, the created lookup table may comprise one or more grid codes, country code, and charging point identity, and wherein the vehicle may look at the charging point identity along with the country code to determine the grid codes. For example, the charging point identity may comprise a Power outlet ID and the vehicle may look at the power outlet ID along with the country code to determine the grid codes.

In some embodiments, processor 202 may configure the communication module to transmit the generated message from the charging point to the vehicle, wherein the vehicle determines the one or more grid codes based on the lookup table.

In some embodiments, processor 202 may configure the communication module to transmit the generated message from the charging point to the vehicle based on a connection between the charging point and the vehicle. In some embodiments, the connection comprises a wired connection. In some embodiments, the connection comprises a wireless connection.

In some embodiments, the generated message provides the one or more grid codes to the vehicle in an absence of a network connection at the vehicle, wherein the one or more grid codes enable the vehicle to perform at least one of charging and discharging based on the connection with the charging point.

Referring to FIG. 2, processor 202 is operable to obtain supply power information from power module 206 and generate a message comprising a value of supply power for the vehicle along with at least one of a first indicator associated with a direction associated with the supply power, a second indicator associated with at least one of charging and discharging operation, a third indicator associated with a phase information of the supply power, and a fourth indicator associated with at least one of a set point and a maximum limit associated with the supply power. In some embodiments, processor 202 may then transmit the generated message to encoding unit 218 to encode the message, wherein the encoded message is transmitted to the vehicle to enable the vehicle to perform at least one of charging and discharging operation based on the information in the encoded message. In some embodiments, the generated message is based on the International Standards Organization (ISO) 15118-2 standard.

In some embodiments, encoding unit 218 performs encoding on the generated message such that the encoded message comprises at least 16-bits, wherein at least 10-bits of the encoded message provides an indication of a value of the supply power; at least 1-bit of the encoded message provides the first indicator; at least 1-bit of the encoded message provides the second indicator; at least 3-bits of the encoded message provides the third indicator; and at least 1-bit of the encoded message provides the fourth indicator.

In some embodiments, encoding unit 218 performs encoding on the generated message such that the encoded message comprises at least 16-bits, wherein at least bits 0-9 of the encoded message provides an indication of a value of the supply power, at least bit 10 of the encoded message provides the first indicator, at least bit 11 of the encoded message provides the second indicator, at least bits 12-14 of the encoded message provide the third indicator, and at least bit 15 provides the fourth indicator.

In some embodiments, a value of ‘0’ associated with bit 10 indicates at least one of a set point and a maximum limit associated with the supply power in a grid-to-vehicle (G2V) operation mode and a value of ‘1’ associated with bit 10 indicates at least one of a set point and a maximum limit associated with the supply power in a vehicle-to-grid (V2G) operation mode.

In some embodiments, a value of ‘0’ associated with bit 11 indicates the charging operation and a value of ‘1’ associated with bit 11 indicates the discharging operation.

In some embodiments, bit 12 provides a first phase information associated with a first phase of the supply power, bit 13 provides a second phase information associated with a second phase of the supply power, and bit 14 provides a third phase information associated with a third phase of the supply power.

In some embodiments, the processor is configured to encode at least bits 10, 11, and 15 of the encoded message to provide at least one of vehicle-to-grid (V2G) set point, grid-to-vehicle (G2V) set point, V2G maximum limit, and G2V maximum limit, wherein the V2G set point, the G2V set point, the V2G maximum limit, and the G2V maximum limit are associated with the supply power.

In some embodiments, a value of ‘0’ associated with bits 10, 11, and 15 indicates a grid-to-vehicle supply power set point for charging operation. In some embodiments, a value of ‘0’ associated with bits 10, 11, and 15, a value of ‘1’ associated with bit 12 and value of ‘0’ associated with bits 13 and 14 indicates a grid-to-vehicle set point for charging operation associated with a first phase of the supply power. In some embodiments, a value of ‘0’ associated with bits 10, 11, and 15, a value of ‘1’ associated with bit 13 and value of ‘0’ associated with bits 12 and 14 indicates a grid-to-vehicle set point for charging operation associated with a second phase of the supply power. In some embodiments, a value of ‘0’ associated with bits 10, 11, and 15, a value of ‘1’ associated with bit 14 and value of ‘0’ associated with bits 12 and 13 indicates a grid-to-vehicle set point for charging operation associated with a third phase of the supply power.

In some embodiments, a value of ‘0’ associated with bits 10 and 11 and a value of ‘1’ associated with bit 15 indicates a grid-to-vehicle maximum limit for charging operation. In some embodiments, a value of ‘0’ associated with bits 10 and 11, a value of ‘1’ associated with bit 15, a value of ‘1’ associated with bit 12 and value of ‘0’ associated with bits 13 and 14 indicates a grid-to-vehicle maximum limit for charging operation associated with a first phase of the supply power. In some embodiments, a value of ‘0’ associated with bits 10 and 11, a value of ‘1’ associated with bit 15, a value of ‘1’ associated with bit 13 and value of ‘0’ associated with bits 12 and 14 indicates a grid-to-vehicle maximum limit for charging operation associated with a second phase of the supply power. In some embodiments, a value of ‘0’ associated with bits 10 and 11, a value of ‘1’ associated with bit 15, a value of ‘1’ associated with bit 14 and value of ‘0’ associated with bits 12 and 13 indicates a grid-to-vehicle maximum limit for charging operation associated with a third phase of the supply power.

In some embodiments, a value of ‘0’ associated with bit 11 and value of ‘1’ associated with bits 10 and 15 indicates a vehicle-to-grid maximum limit for charging operation. In some embodiments, a value of ‘0’ associated with bit 11, value of ‘1’ associated with bits 10 and 15, a value of ‘1’ associated with bit 12 and value of ‘0’ associated with bits 13 and 14 indicates a vehicle-to-grid maximum limit for charging operation associated with a first phase of the supply power. In some embodiments, a value of ‘0’ associated with bit 11, value of ‘1’ associated with bits 10 and 15, a value of ‘1’ associated with bit 13 and value of ‘0’ associated with bits 12 and 14 indicates a vehicle-to-grid maximum limit for charging operation associated with a second phase of the supply power. In some embodiments, a value of ‘0’ associated with bit 11, value of ‘1’ associated with bits 10 and 15, a value of ‘1’ associated with bit 14 and value of ‘0’ associated with bits 12 and 13 indicates a vehicle-to-grid maximum limit for charging operation associated with a third phase of the supply power.

In some embodiments, a value of ‘1’ associated with bits 10 and 11 and a value of ‘0’ associated with bit 15 indicates a vehicle-to-grid set point for discharging operation. In some embodiments, a value of ‘1’ associated with bits 10 and 11, a value of ‘0’ associated with bit 15 a value of ‘1’ associated with bit 12 and value of ‘0’ associated with bits 13 and 14 indicates a vehicle-to-grid set point for discharging operation associated with a first phase of the supply power. In some embodiments, a value of ‘1’ associated with bits 10 and 11, a value of ‘0’ associated with bit 15 a value of ‘1’ associated with bit 13 and value of ‘0’ associated with bits 12 and 14 indicates a vehicle-to-grid set point for discharging operation associated with a second phase of the supply power. In some embodiments, a value of ‘1’ associated with bits 10 and 11, a value of ‘0’ associated with bit 15, a value of ‘1’ associated with bit 14 and value of ‘0’ associated with bits 12 and 13 indicates a vehicle-to-grid set point for discharging operation associated with a third phase of the supply power.

In some embodiments, a value of ‘1’ associated with bits 11 and 15 and a value of ‘0’ associated with bit 10 indicates a grid-to-vehicle maximum limit for discharging operation. In some embodiments, a value of ‘1’ associated with bits 11 and 15, a value of ‘0’ associated with bit 10, a value of ‘1’ associated with bit 12 and value of ‘0’ associated with bits 13 and 14 indicates a grid-to-vehicle maximum limit for discharging operation associated with a first phase of the supply power. In some embodiments, a value of ‘1’ associated with bits 11 and 15, a value of ‘0’ associated with bit 10, a value of ‘1’ associated with bit 13 and value of ‘0’ associated with bits 12 and 14 indicates a grid-to-vehicle maximum limit for discharging operation associated with a second phase of the supply power. In some embodiments, a value of ‘1’ associated with bits 11 and 15, a value of ‘0’ associated with bit 10, a value of ‘1’ associated with bit 14 and value of ‘0’ associated with bits 12 and 13 indicates a grid-to-vehicle maximum limit for discharging operation associated with a third phase of the supply power.

In some embodiments, a value of ‘1’ associated with bits 10, 11, and 15 indicates a vehicle-to-grid maximum limit for discharging operation. In some embodiments, a value of ‘1’ associated with bits 10, 11, and 15, a value of ‘1’ associated with bit 12 and value of ‘0’ associated with bits 13 and 14 indicates a vehicle-to-grid maximum limit for discharging operation associated with a first phase of the supply power. In some embodiments, a value of ‘1’ associated with bits 10, 11, and 15, a value of ‘1’ associated with bit 13 and value of ‘0’ associated with bits 12 and 14 indicates a vehicle-to-grid maximum limit for discharging operation associated with a second phase of the supply power. In some embodiments, a value of ‘1’ associated with bits 10, 11, and 15 a value of ‘1’ associated with bit 14 and value of ‘0’ associated with bits 12 and 13 indicates a vehicle-to-grid maximum limit for discharging operation associated with a third phase of the supply power.

In some embodiments, the encoded message is transmitted to the vehicle based on an open systems interconnection (OSI) model over a data link layer of the OSI model.

In some embodiments, the encoded message is transmitted from the charging point to the vehicle every 120 milliseconds. In some embodiments, the charging point comprises the EVSE, and system 200 is a component of the EVSE.

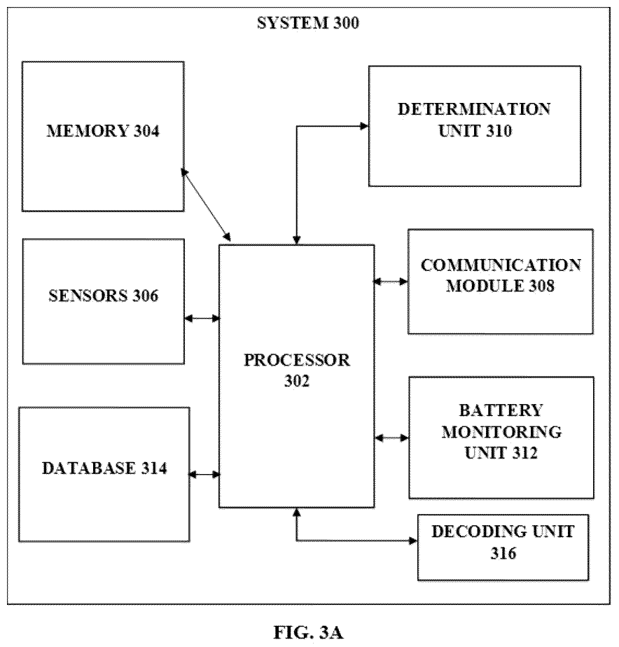

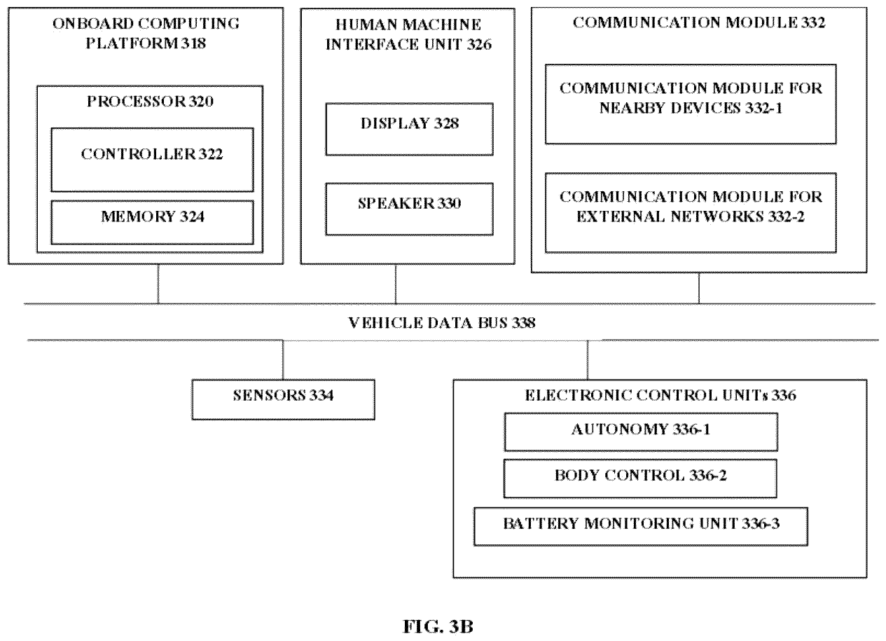

FIG. 3A illustrates a functional block diagram of system 300 associated with a vehicle according to an embodiment.

System 300 comprises processor 302, memory 304, sensors 306, communication module 308, determination unit 310, battery monitoring unit 312, database 314, and decoding unit 316.

Referring to FIG. 3A, processor 302 may be a high-performance, multi-core CPU or system-on-chip (SoC) solution to process vast amounts of data. In some embodiments, processor 302 is communicatively coupled to decoding unit 316 and is configured to decode the message received from the charging point to determine at least one of one or more grid codes associated with the particular location and information related to the supply power. In some embodiments, processor 302 may comprise decoding unit 316.

Processor 302 may comprise Graphics Processing Units (GPUs). GPUs are utilized for their ability to accelerate tasks like image and sensor data processing. Some vehicles may incorporate Field-Programmable Gate Arrays (FPGAs) to efficiently perform specialized computations, while others may leverage Application Specific Integrated Circuits (ASICs) for optimized functions. The choice of processor depends on factors such as the vehicle's level of autonomy, processing requirements, power consumption, and thermal considerations. Processors, also known as central processing units (CPUs), are the heart and brain of any computer or electronic device capable of executing instructions. Processor or processors' function is to process data and perform calculations, etc. At the core of their operation lies data processing, where they handle arithmetic and logical operations on data stored in memory. CPUs execute instructions, which are sets of specific operations encoded in machine language, to perform various tasks. The control unit within, or interacting with, the processor manages and coordinates the execution of instructions, fetching them from memory, decoding them, and directing the appropriate components to execute the instruction. To ensure a controlled and orderly flow of tasks, processors use an internal clock that generates regular electrical pulses, synchronizing their operations through clock cycles. Processors support multitasking environments, rapidly switching between executing different tasks for various applications. Additionally, they may work with the operating system to manage virtual memory, allowing programs to access more memory than is physically available, and to efficiently manage memory usage. Processor or processors may be integrated with security features, including hardware-level encryption, memory protection, and support for secure execution environments, enhancing the system's security against potential threats. The processor may run sophisticated algorithms and artificial intelligence (AI) software to analyze sensor data, determine conditions associated with the vehicle and a user of the vehicle, interpret the environment, and help in decision making. Its high-performance capabilities and parallel processing help ensure the vehicle can perceive and respond to its surroundings quickly and accurately. In an embodiment, the processor may be a neuromorphic processor, inspired by the human brain, which offers a unique approach to handling AI tasks. Processor 302 interacts with and exchanges data with one or more of the other components or modules of the system, for example, memory 304, sensors 306, communication module 308, determination unit 310, battery monitoring unit 312, database 314, and decoding unit 316.

Referring to FIG. 3A, memory 304 may be a non-volatile memory (NVM) which is utilized in reliable operations of the system, ensuring that data is preserved even during power interruptions or failures. Various NVM technologies are utilized, such as flash memory for storing the operating system and software, EEPROM for retaining configuration data, calibration values, and sensor settings, Ferroelectric RAM (FRAM) for critical real-time information, and emerging technologies like ReRAM for potential performance enhancements due to its high-speed operation and low power consumption. In an embodiment, the memory may be a cloud-based memory. In another embodiment, the memory may be a local memory. In another embodiment, it may be a combination of local and cloud-based memory. Local memory refers to the traditional memory components present in a physical device, such as a computer's RAM, hard disk drives (HDDs), or solid-state drives (SSDs). It provides fast access to data and is directly connected to the device, making it suitable for immediate processing tasks and offline use. On the other hand, cloud-based memory relies on remote servers and services provided by third-party cloud providers to store and manage data over the internet. Systems can access their data from anywhere with an internet connection, allowing for seamless collaboration and scalability. Cloud-based memory is often used for storing large amounts of data, enabling data sharing, and providing backup and disaster recovery solutions. The combination of local memory and cloud-based memory allows for flexible and efficient data management tailored to different needs of the system.

Referring to FIG. 3A, sensors 306 may comprise various sensors such as a temperature sensor, ultrasonic sensors, LIDAR sensors, radar sensors, camera-based sensors, Infrared (IR) sensors, radio frequency identification (RFID) sensors, etc. Sensors, for example, cameras, LIDARs, radars, and ultrasonic sensors, enable autonomous vehicles to detect and recognize objects, obstacles, and pedestrians on the road to enable navigation of the autonomous vehicles. In some embodiments, communication module 308 facilitates communication between different modules within system 300, e.g., communication between the vehicle and other devices, other vehicles, and other infrastructure components or energy source, for example, grid, charging points, etc.

Referring to FIG. 3A, in some embodiments, database 314 may store data associated with various sensors 306, determination unit 310, and battery monitoring unit 312. In some embodiments, database 314 may be locally present in system 300 or may be present in a server associated with a manufacturer of the vehicle or in a cloud server. Processor 302 may fetch the data from the database to obtain a charge level and a threshold level and determine whether the vehicle may charge or discharge by comparing the charge level with the threshold level. Further, database 314 may also store a lookup table to determine the grid codes and a set of decoding rules to determine information associated with the supply power.

Referring to FIG. 3A, communication module 308, determination unit 310, and battery monitoring unit 312 are coupled to processor 202. Communication module 308 is operable to communicate with external devices such as charging points and to receive messages for determining at least one of one or more grid codes and information related to the supply power. In some embodiments, the communication module 308 is operable to communicate based on the ISO 15118-2 protocol. In some embodiments, the communication module is configured to receive the first message and the second message from the charging point.

In some embodiments, battery monitoring unit 312 and determination unit 310 are communicatively coupled to processor 302. Battery monitoring unit 312 provides a battery level associated with a vehicle battery and determination unit 310 compares whether the battery level is above or below a threshold, wherein the threshold is based on a minimum battery level required by the vehicle for its operation. Processor 302 is operable to receive, through the communication module, the comparison results from determination unit 310 and determines whether the vehicle battery needs charging or discharging. Accordingly, processor 302 transmits through the communication module to the charging point to perform at least one of charging or discharging. In some embodiments, if the battery level is above the threshold, the processor determines to discharge the vehicle battery and accordingly communicates to the charging point or to a centralized server or cloud server. In some embodiments, if the battery level is below the threshold, the processor determines to charge the vehicle battery and accordingly communicates to the charging point or to the centralized server or cloud server. In some embodiments, communication module 308 receives the encoded message from the charging point based on the determination. In some embodiments, decoding unit 316 may decode the information related to the supply power from the encoded message and communicate the decoded information to the processor to enable charging or discharging the vehicle battery based on the decoded information.

FIG. 3B illustrates a block diagram of electronic components of the vehicle according to an embodiment.

Referring to FIG. 3B, the vehicle comprising various electronic components, such as, on-board computing platform 318, human-machine interface (HMI) unit 326, communication module 332, sensors 334, electronic control units (ECUs) 336, and vehicle data bus 338, is shown. FIG. 3B illustrates an example architecture of some of the electronic components, as shown in FIG. 3A. On-board computing platform 318 comprises processor 320 (also referred to as a microcontroller unit or a controller) and memory 324. In the illustrated example, processor 320 of on-board computing platform 318 is structured to comprise controller 322. In other examples, controller 322 is incorporated into another ECU with its own processor and memory. The processor may be any suitable processing device or set of processing devices such as, but not limited to, a microprocessor, a microcontroller-based platform, an integrated circuit, one or more field-programmable gate arrays (FPGAs), and/or one or more application specific integrated circuits (ASICs). The memory may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid-state drives, etc.). In some examples, memory 324 comprises multiple kinds of memory, particularly volatile memory, and non-volatile memory. Memory 324 is computer-readable media on which one or more sets of instructions, such as the software for operating the methods of the present disclosure, can be embedded. The instructions may embody one or more of the methods or logic as described herein. For example, the instructions reside completely, or at least partially, within any one or more of the memory 324, the computer-readable medium, and/or within processor 320 during execution of the instructions.

HMI unit 326 provides an interface between the vehicle and a user. HMI unit 326 comprises digital and/or analog interfaces (e.g., input devices and output devices) to receive input from, and display information for, the user(s). The input devices comprise, for example, a control knob, an instrument panel, a digital camera for image capture and/or visual command recognition, a touch screen, an audio input device (e.g., cabin microphone), buttons, or a touchpad. The output devices may comprise instrument cluster outputs (e.g., dials, lighting devices), haptic devices, actuators, display 328 (e.g., a heads-up display, a center console display such as a liquid crystal display (LCD), an organic light emitting diode (OLED) display, a flat panel display, a solid-state display, etc.), and/or speaker 330. For example, display 328, speaker 330, and/or other input and output device(s) of HMI unit 326 are operable to emit an alert, such as an alert to request manual takeover to an operator (e.g., a driver) of the vehicle. Further, HMI unit 326 of the illustrated example comprises hardware (e.g., a processor or controller, memory, storage, etc.) and software (e.g., an operating system, etc.) for an infotainment system that is presented via display 328.

Sensors 334 are arranged in and/or around the vehicle to monitor the interior regions of the vehicle and/or an environment in which the vehicle is driving. One or more of the sensors may be mounted to measure various parameters around an exterior of the vehicle. Additionally, or alternatively, one or more of sensors may be mounted inside a cabin of the vehicle or in a body of the vehicle (e.g., an engine compartment, wheel wells, etc.) to measure properties of the vehicle and/or interior sensing of the vehicle. For example, sensors 334 comprise accelerometers, odometers, tachometers, pitch and yaw sensors, wheel speed sensors, microphones, tire pressure sensors, biometric sensors, ultrasonic sensors, infrared sensors, Light Detection and Ranging (LIDAR/lidar), Radio Detection and Ranging System (radar), Global Positioning System (GPS), millimeter wave (mmWave) sensors, cameras and/or sensors of any other suitable type. According to an embodiment of the system, the one or more sensors associated with the vehicle comprises camera-based sensors or a camera coupled with a computer vision system.

Referring to FIG. 3B, ECUs 336 monitor and control the subsystems of the vehicle. For example, ECUs 336 are discrete sets of electronics that comprise their own circuit(s) (e.g., integrated circuits, microprocessors, memory, storage, etc.) and firmware, sensors, actuators, and/or mounting hardware. ECUs 336 communicates and exchanges information via vehicle data bus 338. Additionally, ECUs 336 may communicate properties (e.g., status of the ECUs, sensor readings, control state, error, and diagnostic codes, etc.) and/or receive requests from each other. For example, the vehicle may have many ECUs 336 that are positioned in various locations around the vehicle and are communicatively coupled by vehicle data bus 338.

In the illustrated example, ECUs 336 comprise autonomy unit 336-1, body control module 336-2, and battery monitoring unit 336-3. For example, autonomy unit 336-1 is operable to perform autonomous and/or semi-autonomous driving maneuvers (e.g., defensive driving maneuvers) of the vehicle based upon, at least in part, instructions received from controller 322 and/or data collected by sensors 334 (e.g., object detection sensors). Further, body control module 336-2 controls one or more subsystems throughout the vehicle, such as power windows, power locks, an immobilizer system, power mirrors, etc. For example, body control module 336-2 comprises circuits that drive one or more relays (e.g., to control wiper fluid, etc.), brushed direct current (DC) motors (e.g., to control power seats, power locks, power windows, wipers, etc.), stepper motors, LEDs, safety systems (e.g., seatbelt pretensioner, air bags, etc.), etc. For example, battery monitoring unit 336-3 (similar to battery monitoring unit 312 of FIG. 3A) is operable to monitor the battery level associated with the vehicle battery to enable the processor to determine whether to perform charging or discharging operation. Based on the determination, the processor initiates communication with the charging point for at least one of the charging or discharging operations and receives an encoded message. The processor enables charging or discharging based on the information in the encoded message.

Referring to FIG. 3B, vehicle data bus 338 communicatively couples communication module 332, on-board computing platform 318, HMI unit 326, sensors 334, and ECUs 336. In some examples, vehicle data bus 338 comprises one or more data buses. Vehicle data bus 338 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

Referring to FIG. 3B, communication module 332 may comprise a near field communication module or a communication module for nearby device 332-1 and far field communication module or communication module for external network 332-2. Communication module for nearby devices 332-1 is operable to communicate with other nearby communication devices. In an example, communication module 332 comprises a dedicated short-range communication (DSRC) module. A DSRC module comprises antenna(s), radio(s) and software to communicate with nearby vehicle(s) via vehicle-to-vehicle (V2V) communication, infrastructure-based module(s) via vehicle-to-infrastructure (V2I) communication, and/or, more generally, nearby communication device(s) (e.g., a mobile device-based module) via vehicle-to-everything (V2X) communication. V2V communication allows vehicles to share information such as speed, position, direction, and other relevant data, enabling them to cooperate and coordinate their actions to improve safety, efficiency, and mobility on the road. It may rely on dedicated short-range communication (DSRC) and other wireless protocols that enable fast and reliable data transmission between vehicles. V2V communication, which is a form of wireless communication between vehicles, allows vehicles to exchange information and coordinate with other vehicles on the road.

Additionally, or alternatively, communication module for external networks 332-2 comprises a cellular vehicle-to-everything (C-V2X) module. A C-V2X module comprises hardware and software to communicate with other vehicle(s) via V2V communication, infrastructure-based module(s) via V2I communication, and/or, more generally, nearby communication devices (e.g., mobile device-based modules) via V2X communication. For example, a C-V2X module is operable to communicate with nearby devices (e.g., vehicles, roadside units, mobile devices of users, etc.) directly and/or via cellular networks. Currently, standards related to C-V 2X communication are being developed by the 3^{rd} Generation Partnership Project. Further, communication module 332-2 is operable to communicate with external networks. For example, communication module 332-2 comprises hardware (e.g., processors, memory, storage, antenna, etc.) and software to control wired or wireless network interfaces. In the illustrated example, the communication module 332-2 comprises one or more communication controllers for wireless networks, satellite communication network, microwave communication network, fiber optic communication network, cellular networks (e.g., Global System for Mobile Communications (GSM), Universal Mobile Telecommunications System (UMTS), Long Term Evolution (LTE), Code Division Multiple Access (CDMA)), fifth generation 5G networks, Near Field Communication (NFC) and/or other standards-based networks (e.g., WiMAX (IEEE 802.16m), local area wireless network (including IEEE 802.11 a/b/g/n/ac or others), Wireless Gigabit (IEEE 802.11ad), etc.). In some examples, the communication module for external networks 322-2 comprises a wired or wireless interface (e.g., an auxiliary port, a Universal Serial Bus (USB) port, a Bluetooth® wireless node, etc.) to communicatively couple with a mobile device (e.g., a smart phone, a wearable, a smart watch, a tablet, etc.). In such examples, the vehicle may communicate with the external network via the coupled mobile device. The external network(s) may be a public network, such as the Internet, a private network, such as an intranet, or combinations thereof, and may utilize a variety of networking protocols now available or later developed including, but not limited to, TCP/IP-based networking protocols.

The communication module comprises a hardware component comprising, a vehicle gateway system comprising a microcontroller, a transceiver, a power management integrated circuit, an Internet of Things device capable of transmitting one of an analog and a digital signal over one of a telephone, a communication, either wired or wirelessly.

Autonomy unit 336-1 of the illustrated example is operable to perform autonomous and/or semi-autonomous driving maneuvers, such as defensive driving maneuvers, for the vehicle. For example, autonomy unit 336-1 performs the autonomous and/or semi-autonomous driving maneuvers based on data collected by sensors 334. In some examples, autonomy unit 336-1 is operable to operate a fully autonomous system, a park-assist system, an advanced driver-assistance system (ADAS), and/or other autonomous system(s) for the vehicle.

Further, in the illustrated example, controller (or control module) 322 is operable to monitor an ambient environment of the vehicle. For example, to enable autonomy unit 336-1 to perform autonomous and/or semi-autonomous driving maneuvers, the controller collects data that is collected by sensors 334 of the vehicle. In some examples, the controller collects location-based data via communication module 332-1 and/or another module (e.g., a GPS receiver) to facilitate the autonomy unit in performing autonomous and/or semi-autonomous driving maneuvers. Additionally, the controller collects data from (i) adjacent vehicle(s) via communication module 332-1 and V2V communication and/or (ii) roadside unit(s) via communication module 332-1 and V2I communication to further facilitate autonomy unit 336-1 in performing autonomous and/or semi-autonomous driving maneuvers.

According to an embodiment, the communication module supports a communication protocol, wherein the communication protocol comprises at least one of an Advanced Message Queuing Protocol (AMQP), Message Queuing Telemetry Transport (MQTT) protocol, Simple (or Streaming) Text Oriented Message Protocol (STOMP), Zigbee protocol, Unified Diagnostic Services (UDS) protocol, Open Diagnostic eXchange format (ODX) protocol, Diagnostics Over Internet Protocol (DoIP), On-Board Diagnostics (OBD) protocol, and a predefined protocol standard. In some embodiments, communication module 332 is configured to communicate with the charging point using ISO-15118-2 protocol using the OSI model.

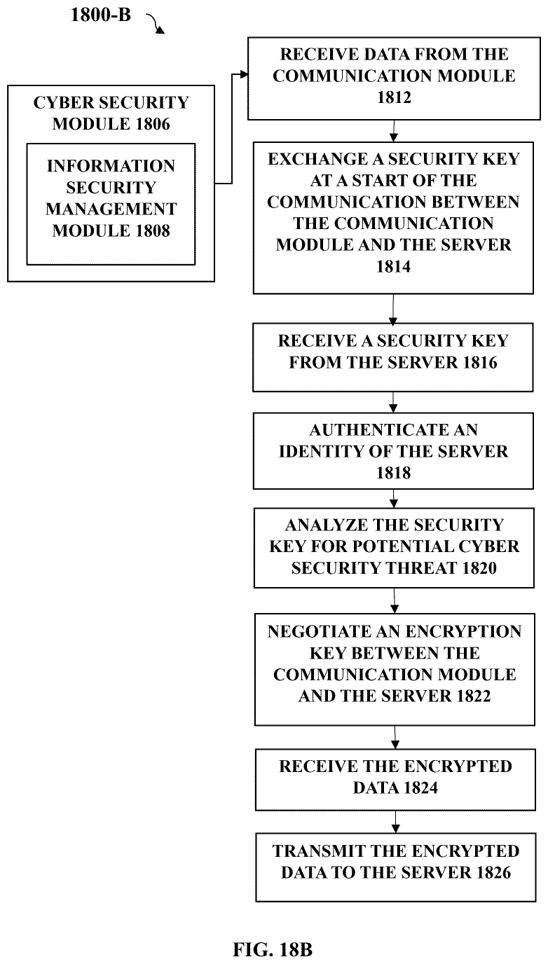

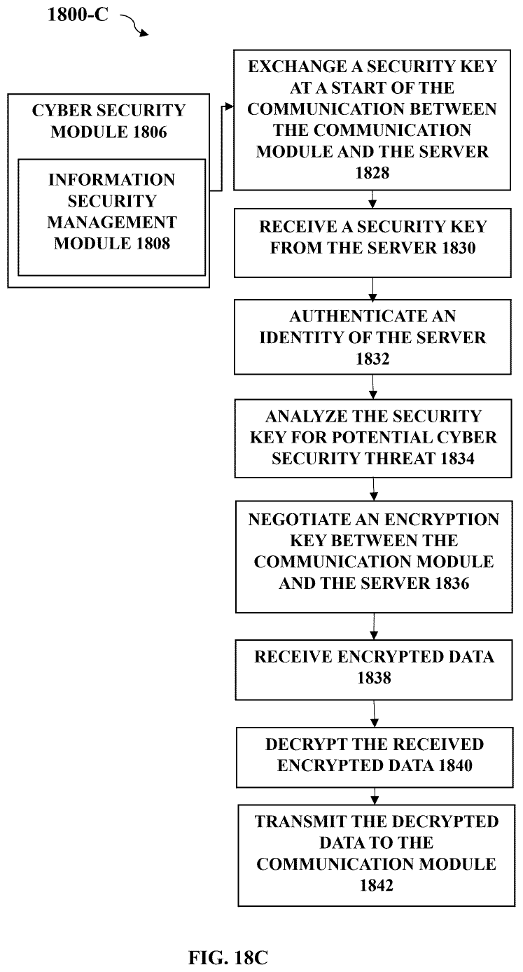

In an embodiment, communication module 332 may comprise cyber security module 1806 (shown in FIG. 18A). In some embodiments, communication module 332 may communicate with cyber security module 1806 to perform secure communication with nearby devices and external networks. In one aspect, a secure communication management (SCMT) computer device for providing secure data connections is provided. The SCMT computer device comprises a processor in communication with memory. The processor is programmed to receive, from a first device, a first data message. The first data message is in a standardized data format. The processor is also programmed to analyze the first data message for potential cyber security threats. If the determination is that the first data message does not contain a cyber security threat, the processor is further programmed to convert the first data message into a first data format associated with the vehicle environment and transmit the converted first data message to the vehicle system using a first communication protocol associated with the vehicle system. According to an embodiment, secure authentication for data transmissions comprises, provisioning a hardware-based security engine (HSE) located in communications system, said HSE having been manufactured in a secure environment and certified in said secure environment as part of an approved network; performing asynchronous authentication, validation and encryption of data using said HSE, storing user permissions data and connection status data in an access control list used to define allowable data communications paths of said approved network, enabling communications of the communications system with other computing system subjects to said access control list, performing asynchronous validation and encryption of data using security engine including identifying a user device (UD) that incorporates credentials embodied in hardware using a hardware-based module provisioned with one or more security aspects for securing the system, wherein security aspects comprising said hardware-based module communicating with a user of said user device and said HSE.

In some embodiments, communication module 332 may receive a decision related to charging or discharging the vehicle battery from processor 320 based on the charge level monitored by battery monitoring unit 336-3. Communication module 332 may further communicate the decision to the charging point or the centralized server or the cloud server.

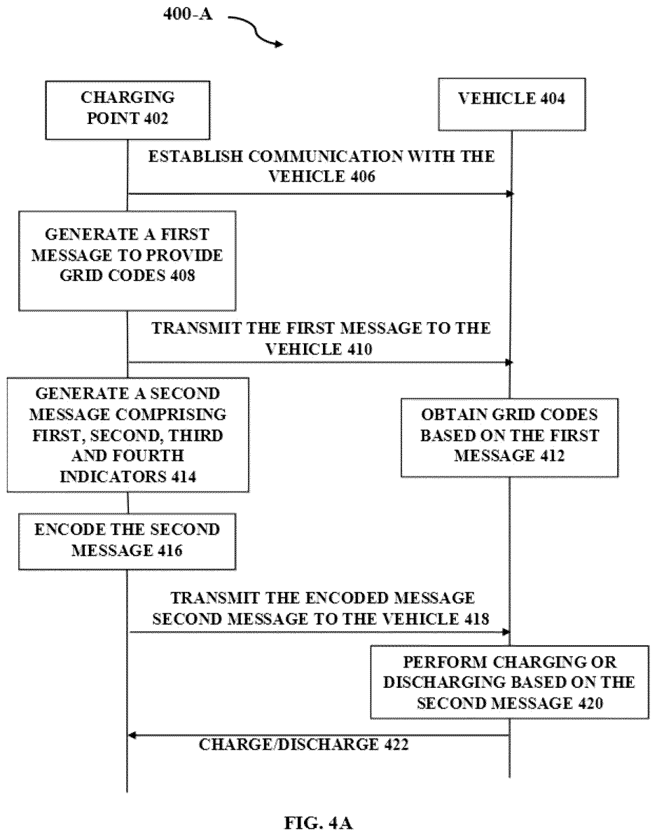

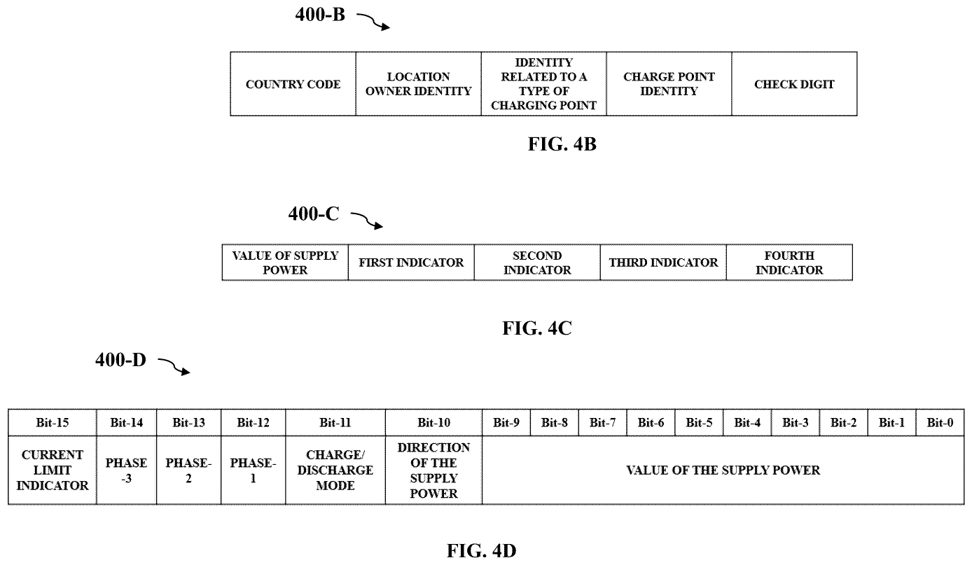

FIG. 4A illustrates message flow diagram 400-A between the vehicle and the charging point according to an embodiment.

Referring to FIG. 4A, charging point 402 may detect a vehicle 404 plugged in for charging/discharging and establish communication with the vehicle at step 406. Charging point 402, at step 408, generates a first message to provide one or more grid codes to the vehicle. In some embodiments, the first message comprises at least one of a country code, a location owner identity, identity related to a type of charging point, and a charge point identity along with a check digit. The charging point, at step 410, transmits the first message to the vehicle. The vehicle, at step 412, obtains one or more grid codes from the first message. In some embodiments, the vehicle includes a lookup table provided by the charging point, the centralized server, or the cloud server to determine the one or more grid codes based on the information in the first message. Charging point 402, at step 414, generates a second message. In some embodiments, the second message comprises a value of supply power for a vehicle along with at least one of a first indicator associated with a direction associated with the supply power, a second indicator associated with at least one of charging and discharging operation, a third indicator associated with a phase information of the supply power, and a fourth indicator associated with at least one of a set point and a maximum limit associated with the supply power. Further, the charging point proceeds to encode the second message at step 416. In some embodiments, encoding the second message comprises bit coding the message from the charging point to the vehicle to include at least one of a direction information, phase information, maximum limit, and set point associated with the supply power. In some embodiments, the encoded second message comprises an ISO15118-2 protocol based message comprising at least 16-bits, wherein at least bits 0-9 of the encoded second message provides an indication of a value of the supply power, at least bit 10 of the encoded second message provides the first indicator, at least bit 11 of the encoded second message provides the second indicator, at least bits 12-14 of the encoded second message provides the third indicator, and at least bit 15 of the encoded second message provides the fourth indicator.

Charging point 402, at step 418, transmits the encoded second message to vehicle 404. Vehicle 404, at step 420, decodes the second message to determine whether to perform charging operation or discharging operation. The vehicle at step 422, performs either charging operation or discharging operation based on the determination.

FIG. 4B illustrates format 400-B of a first message according to an embodiment.

Referring to FIG. 4B, the first message comprises a country code, location owner identity, identity related to a type of charging point, charging point identity, and check digit. In some embodiments the charging point comprises the EVSE and the first message comprises the EVSE ID.

FIG. 4C illustrates format 400-C of a second message according to an embodiment.

Referring to FIG. 4C, the second message comprises the value of supply power, a first indicator, second indicator, third indicator, and a fourth indicator. In some embodiments, the first indicator is associated with a direction associated with the supply power, the second indicator is associated with at least one of charging and discharging operation, the third indicator is associated with a phase information of the supply power, and the fourth indicator is associated with at least one of a set point and a maximum limit associated with the supply power

FIG. 4D illustrates format 400-D of an encoded message according to an embodiment.

Referring to FIG. 4D, the encoded message comprises a 16-bit ISO15118-2 based message. In some embodiments, bits 0-9 of the encoded message are encoded to indicate the value of the supply power, bit 10 is encoded to indicate the direction of the supply power, bit 11 is encoded to indicate the charge/discharge mode, bit 12 is encoded to indicate a first information associated with the first phase of the supply power, bit 13 is encoded to indicate a second information associated with a second phase of the supply power, bit 14 is encoded to indicate a third information associated with a third phase of the supply power, and bit 15 is encoded to indicate a current limit. In some embodiments, bit 15 is encoded to indicate a maximum value of the supply power for charging or discharging operation. In some embodiments, bit 15 is encoded to indicate a set point value.

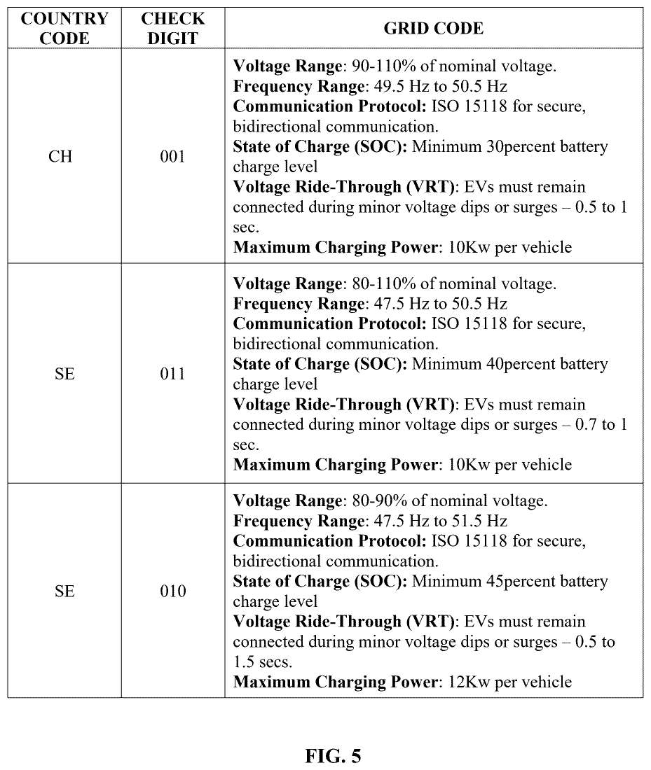

FIG. 5 illustrates the format of a lookup table according to an embodiment.

Referring to FIG. 5, the lookup table comprises at least a country code, check digit, and grid code, wherein the grid code is associated with the country code. In some embodiments, when there are multiple grid codes associated with the country code, the check digit enables selecting a particular grid code based on the location of the vehicle within the country. In some embodiments, the lookup table may comprise at least a country code, a charging point identity or power outlet ID, and grid codes, wherein the grid code is associated with the country code. In some embodiments, when there are multiple grid codes associated with the country code, the charging point identity or the power outlet ID may enable selecting a particular grid code based on the location of the vehicle within the country. In some embodiments, the lookup table may be created in a centralized server and distributed to the charging point and the vehicle. In some embodiments, the lookup table may be loaded in the charging point from the centralized server or a cloud server which in turn transmits the lookup table to the vehicle. In some embodiments, the charging point may be configured to create a lookup table comprising the one or more grid codes associated with at least one of the country code and the check digit in the generated message; and transmit the created lookup table to the vehicle, wherein the lookup table enables the vehicle to determine the one or more grid codes associated with a particular location. In some embodiments, the vehicle may receive the lookup table through a network such as, but not limited to cellular network, internet, GPS, etc. In some embodiments, the vehicle may receive the lookup table from the charging point based on the vehicle connecting with the charging point.

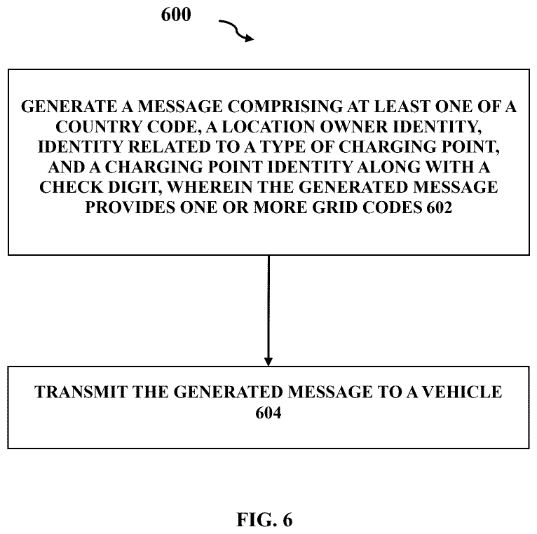

FIG. 6 illustrates a method of communicating grid codes according to an embodiment.

In some embodiments, method 600 may be carried out by a processor using instructions stored in a memory that, when executed, cause the processor to carry out method 600. In an embodiment, method 600 may be performed by system 200 as shown in FIG. 2.

Referring to FIG. 6, method 600 may, at step 602 generate a message comprising at least one of a country code, a location owner identity, identity related to a type of charging point, and a charging point identity along with a check digit, wherein the generated message provides one or more grid codes. Method 600 may, at step 604 transmit the generated message to a vehicle.

In some embodiments, the generated message comprises an electric vehicle supply equipment identity (EVSE ID), wherein the electric vehicle supply equipment identity (EVSE ID) comprises at least 7 characters. In some embodiments, the EVSE ID is encoded using at least 40-bits.

In some embodiments, method 600 further comprises: encoding at least 16-bits of the 40-bits to provide the country code, encoding at least 8-bits of the 40-bits to provide the location owner identity, encoding at least 8-bits of the 40-bits to provide the identity related to the type of charging point, encoding at least 8-bits of the 40-bits to provide the charging point identity, and encoding at least 8-bits to provide the check digit, wherein the check digit is affixed to the EVSE ID.

In some embodiments, method 600 may further create a lookup table comprising the one or more grid codes associated with at least one of the country code and the check digit in the generated message; and transmit the created lookup table to the vehicle, wherein the lookup table enables the vehicle to determine the one or more grid codes associated with a particular location.

In some embodiments, method 600 may further generate the message at a charging point; and transmit the generated message from the charging point to the vehicle based on a connection between the charging point and the vehicle, wherein the communication connection comprises at least one of wired connection and wireless connection.

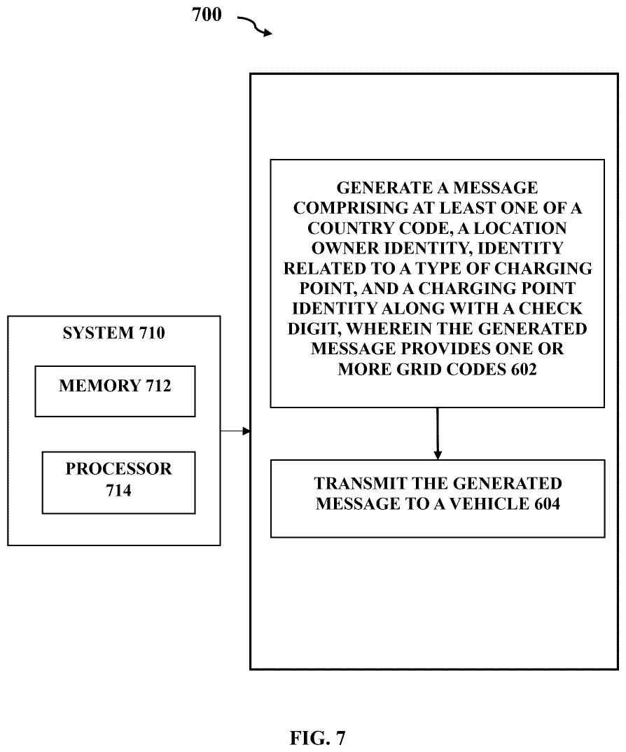

FIG. 7 illustrates block diagram 700 of the system implementing method 600 for communicating grid codes according to an embodiment. According to an embodiment, disclosed is system 710 comprising processor 714; and memory 712, wherein memory 712 storing processor-executable instructions, which on execution, cause the processor to: generate, at step 602, a message comprising at least one of a country code, a location owner identity, identity related to a type of charging point, and a charging point identity along with a check digit, wherein the generated message provides one or more grid codes; and transmit, at step 604, the generated message to a vehicle.

In some embodiments, the processor-executable instructions, which on execution, further cause the processor to create a lookup table comprising the one or more grid codes associated with at least one of the country code and the check digit in the generated message and transmit the created lookup table to the vehicle.

In some embodiments, the processor-executable instructions, which on execution, further cause the processor to transmit the generated message from the charging point to the vehicle, wherein the vehicle determines the one or more grid codes based on the lookup table.

In some embodiments, the processor-executable instructions, which on execution, further cause the processor to transmit the generated message from the charging point to the vehicle based on a connection between the charging point and the vehicle.

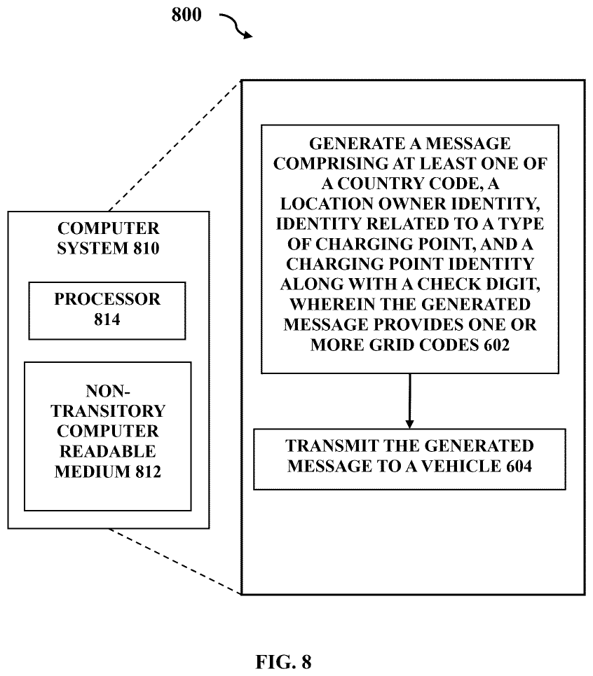

FIG. 8 illustrates block diagram 800 of the method executed by the non-transitory computer-readable medium for communicating grid codes according to an embodiment.

According to an embodiment, disclosed is computer system 810 comprising non-transitory computer-readable medium 812 having stored thereon instructions executable by processor 814 to perform operations comprising: generating a message comprising at least one of a country code, a location owner identity, identity related to a type of charging point, and a charge point identity along with a check digit, wherein the generated message provides one or more grid codes (step 602); and transmitting the generated message to a vehicle (step 604), wherein the generated message comprises an electric vehicle supply equipment identity (EVSE ID), wherein the EVSE ID comprises at least 7 characters and wherein the EVSE ID is encoded using at least 40-bits.

In some embodiments, non-transitory computer-readable medium 812 further comprises instructions to perform operations comprising: encoding at least 16-bits of the 40-bits to provide the country code; encoding at least 8-bits of the 40-bits to provide the location owner identity; encoding at least 8-bits of the 40-bits to provide the identity related to the type of charging point; encoding at least 8-bits of the 40-bits to provide the charging point identity; and encoding at least 8-bits to provide the check digit, wherein the check digit is affixed to the EVSE ID.

In some embodiments, non-transitory computer-readable medium 812 further comprises instructions to perform operations comprising: creating a lookup table comprising the one or more grid codes associated with at least one of the country code and the check digit in the generated message; and transmitting the created lookup table to the vehicle, wherein the lookup table enables the vehicle to determine the one or more grid codes associated with a particular location.

In some embodiments, non-transitory computer-readable medium 812 further comprises instructions to perform operations comprising: generating the message at a charging point; and transmitting the generated message from the charging point to the vehicle based on a connection between the charging point and the vehicle, wherein the connection comprises at least one of a wired connection and a wireless connection.

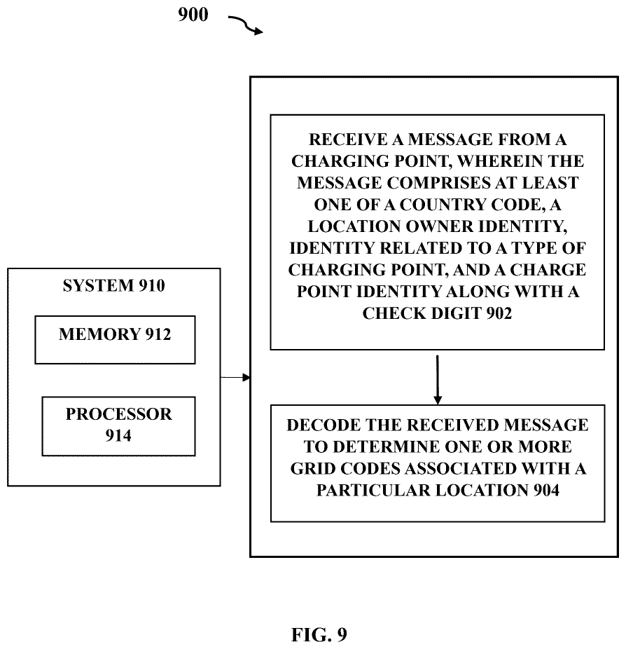

FIG. 9 illustrates block diagram 900 of the system implementing a method for determining grid codes according to an embodiment.

According to an embodiment, disclosed is system 910 comprising processor 914; and memory 912, wherein memory 912 storing processor-executable instructions, which on execution, cause the processor to: receive, at step 902, a message from a charging point, wherein the message comprises at least one of a country code, a location owner identity, identity related to a type of charging point, and a charge point identity along with a check digit; and decode, at step 904, the received message to determine one or more grid codes associated with a particular location.

In some embodiments, the processor-executable instructions, which on execution, further cause the processor to identify at least one of the country code and the check digit to determine the one or more grid codes.

In some embodiment, the processor-executable instructions, which on execution, further cause the processor to obtain a lookup table from the charging point; and determine the one or more grid codes based on the lookup table, wherein the lookup table comprises a mapping between at least one of the country code and the check digit to the one or more grid codes.

In some embodiments, the received message comprises an electric vehicle supply equipment identity (EVSE ID) and the processor-executable instructions, which on execution, further cause the processor to receive the electric vehicle supply equipment identity (EVSE ID) based on a connection between the charging point and the vehicle, wherein the connection comprises at least one of a wired connection and a wireless connection.

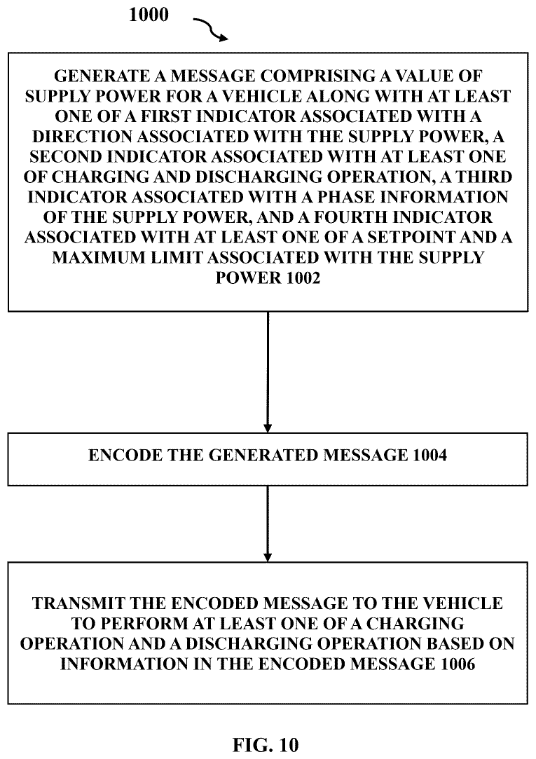

FIG. 10 illustrates a flow chart describing method 1000 for communicating charging and/or discharging information according to an embodiment.

In some embodiments, method 1000 may be carried out by a processor using instructions stored in a memory that, when executed, cause the processor to carry out method 1000. In an embodiment, method 1000 may be performed by system 200 as shown in FIG. 2.

Referring to FIG. 10, method 1000 may, at step 1002 generate a message comprising a value of supply power for a vehicle along with at least one of a first indicator associated with a direction associated with the supply power, a second indicator associated with at least one of charging and discharging operation, a third indicator associated with a phase information of the supply power, and a fourth indicator associated with at least one of a set point and a maximum limit associated with the supply power. Further, method 1000 may, at step 1004 encode the generated message, and at step 1006 transmit the encoded message to the vehicle to perform at least one of a charging operation and a discharging operation based on information in the encoded message.

In some embodiments, the encoded message comprises at least 16-bits and method 1000 further comprises encoding at least 10-bits of the encoded message to provide an indication of a value of the supply power, encoding at least 1-bit of the encoded message to provide the first indicator, encoding at least 1-bit of the encoded message to provide the second indicator, encoding at least 3-bits of the encoded message to provide the third indicator, and encoding at least 1-bit of the encoded message to provide the fourth indicator.

According to an embodiment, the method 1000 further comprises: encoding at least bits 0-9 of the encoded message to provide an indication of a value of the supply power; encoding at least bit 10 of the encoded message to provide the first indicator; encoding at least bit 11 of the encoded message to provide the second indicator; encoding at least bits 12-14 of the encoded message to provide the third indicator; and encoding at least bit 15 of the encoded message to provide the fourth indicator.

In some embodiments, method 1000 further comprises: encoding bit 10 of the encoded message with a value of ‘0’ to indicate at least one of a set point and a maximum limit associated with the supply power in a grid-to-vehicle (G2V) operation mode.

In some embodiments, method 1000 further comprises: encoding bit 10 of the encoded message with a value of ‘1’ to indicate at least one of a set point and a maximum limit associated with the supply power in a vehicle-to-grid (V2G) operation mode.

In some embodiments, method 1000 further comprises: encoding bit 11 of the encoded message with a value of ‘0’ to indicate the charging operation; and encoding bit 11 of the encoded message with a value of ‘1’ to indicate the discharging operation.

In some embodiments, method 1000 further comprises: encoding bit 12 with a value of ‘1’ to indicate a first phase information associated with a first phase of the supply power; encoding bit 13 with a value of ‘1’ to indicate a second phase information associated with a second phase of the supply power; and encoding bit 14 with a value of ‘1’ to indicate a third phase information associated with a third phase of the supply power.

In some embodiments, method 1000 further comprises: encoding bits 10, 11, and 15 with a value of ‘0’, bit 12 with a value of ‘1’, and bits 13 and 14 with a value of ‘0’ to indicate a grid-to-vehicle set point for charging operation associated with a first phase of the supply power.

In some embodiments, method 1000 further comprises: encoding bits 10, 11, and 15 with a value of ‘0’, bit 13 with a value of ‘1’, and bits 12 and 14 with a value of ‘0’ to indicate a grid-to-vehicle set point for charging operation associated with a second phase of the supply power.

In some embodiments, method 1000 further comprises: encoding bits 10, 11, and 15 with a value of ‘0’, bit 14 with a value of ‘1’, and bits 12 and 13 with a value of ‘0’ to indicate a grid-to-vehicle set point for charging operation associated with a third phase of the supply power.

In some embodiments, method 1000 further comprises: encoding bits 10, 11, and 15 with a value of ‘0’ and bits 12, 13, and 14 with a value of ‘1’ to indicate a grid-to-vehicle set point for charging operation associated with all three phases of the supply power.

In some embodiments, method 1000 further comprises: encoding bits 10 and 11 with a value ‘0’, bit 15 with a value ‘1’, bit 12 with a value ‘1’, and bits 13 and 14 with a value ‘0’ to indicate a grid-to-vehicle maximum limit associated with a first phase of the supply power for charging operation.

In some embodiments, method 1000 further comprises: encoding bits 10 and 11 with a value ‘0’, bit 15 with a value ‘1’, bit 13 with a value ‘1’, and bits 12 and 14 with a value ‘0’ to indicate a grid-to-vehicle maximum limit associated with a second phase of the supply power for charging operation.

In some embodiments, method 1000 further comprises: encoding bits 10 and 11 with a value ‘0’, bit 15 with a value ‘1’, bit 14 with a value ‘1’, and bits 12 and 13 with a value ‘0’ to indicate a grid-to-vehicle maximum limit associated with a third phase of the supply power for charging operation.

In some embodiments, method 1000 further comprises: encoding bits 10 and 11 with a value ‘0’, bit 15 with a value ‘1’ and bits 12, 13, and 14 with a value ‘1’ to indicate a grid-to-vehicle maximum limit associated with all three phases of the supply power for charging operation.

In some embodiments, method 1000 further comprises: encoding bit 11 with a value of ‘0’, bits 10 and 15 with a value of ‘1’, bit 12 with a value of ‘1’, bits 13 and 14 with a value of ‘0’ to indicate a vehicle-to-grid maximum limit associated with a first phase of the supply power for charging operation.

In some embodiments, method 1000 further comprises: encoding bit 11 with a value of ‘0’, bits 10 and 15 with a value of ‘1’, bit 13 with a value of ‘1’, bits 12 and 14 with a value of ‘0’ to indicate a vehicle-to-grid maximum limit associated with a second phase of the supply power for charging operation.

In some embodiments, method 1000 further comprises: encoding bit 11 with a value of ‘0’, bits 10 and 15 with a value of ‘1’, bit 14 with a value of ‘1’, bits 12 and 13 with a value of ‘0’ to indicate a vehicle-to-grid maximum limit associated with a third phase of the supply power for charging operation.

In some embodiments, method 1000 further comprises: encoding bit 11 with a value of ‘0’, bits 10 and 15 with a value of ‘1’ and bits 12, 13, and 14 with a value of ‘1’ to indicate a vehicle-to-grid maximum limit associated with all three phases of the supply power for charging operation.

In some embodiments, method 1000 further comprises: encoding bits 10 and 11 with a value ‘1’, bit 15 with a value ‘0’, bit 12 with a value ‘1’, and bits 13 and 14 with a value ‘0’ to indicate a vehicle-to-grid set point associated with a first phase of the supply power for discharging operation.

In some embodiments, method 1000 further comprises: encoding bits 10 and 11 with a value ‘1’, bit 15 with a value ‘0’, bit 13 with a value ‘1’, and bits 12 and 14 with a value ‘0’ to indicate a vehicle-to-grid set point associated with a second phase of the supply power for discharging operation.

In some embodiments, method 1000 further comprises: encoding bits 10 and 11 with a value ‘1’, bit 15 with a value ‘0’, bit 14 with a value ‘1’, and bits 12 and 13 with a value ‘0’ to indicate a vehicle-to-grid set point associated with a third phase of the supply power for discharging operation.

In some embodiments, method 1000 further comprises: encoding bits 10 and 11 with a value ‘1’, bit 15 with a value ‘0’ and bits 12, 13, and 14 with a value ‘1’ to indicate a vehicle-to-grid set point associated with all three phases of the supply power for discharging operation.

In some embodiments, method 1000 further comprises: encoding bits 11 and 15 with a value ‘1’, bit 10 with a value ‘0’, bit 12 with a value ‘1’, and bits 13 and 14 with a value ‘0’ to indicate a grid-to-vehicle maximum limit associated with a first phase of the supply power for discharging operation.

In some embodiments, method 1000 further comprises: encoding bits 11 and 15 with a value ‘1’, bit 10 with a value ‘0’, bit 13 with a value ‘1’, and bits 12 and 14 with a value ‘0’ to indicate a grid-to-vehicle maximum limit associated with a second phase of the supply power for discharging operation.

In some embodiments, method 1000 further comprises: encoding bits 11 and 15 with a value ‘1’, bit 10 with a value ‘0’, bit 14 with a value ‘1’, and bits 12 and 13 with a value ‘0’ to indicate a grid-to-vehicle maximum limit associated with a third phase of the supply power for discharging operation.

In some embodiments, method 1000 further comprises: encoding bits 11 and 15 with a value ‘1’, bit 10 with a value ‘0’ and bits 12, 13, and 14 with a value ‘1’ to indicate a grid-to-vehicle maximum limit associated with all three phases of the supply power for discharging operation.

In some embodiments, method 1000 further comprises: encoding bits 10, 11, and 15 with a value ‘1’, bit 12 with a value ‘1’, and bits 13 and 14 with a value ‘0’ to indicate a vehicle-to-grid maximum limit associated with a first phase of the supply power for discharging operation.

In some embodiments, method 1000 further comprises: encoding bits 10, 11, and 15 with a value ‘1’, bit 13 with a value ‘1’, and bits 12 and 14 with a value ‘0’ to indicate a vehicle-to-grid maximum limit associated with a second phase of the supply power for discharging operation.

In some embodiments, method 1000 further comprises: encoding bits 10, 11, and 15 with a value ‘1’, bit 14 with a value ‘1’, and bits 12 and 13 with a value ‘0’ to indicate a vehicle-to-grid maximum limit associated with a third phase of the supply power for discharging operation.

In some embodiments, method 1000 further comprises: encoding bits 10, 11, and 15 with a value ‘1’ and bits 12, 13, and 14 with a value ‘1’ to indicate a vehicle-to-grid maximum limit associated with all three phases of the supply power for discharging operation.

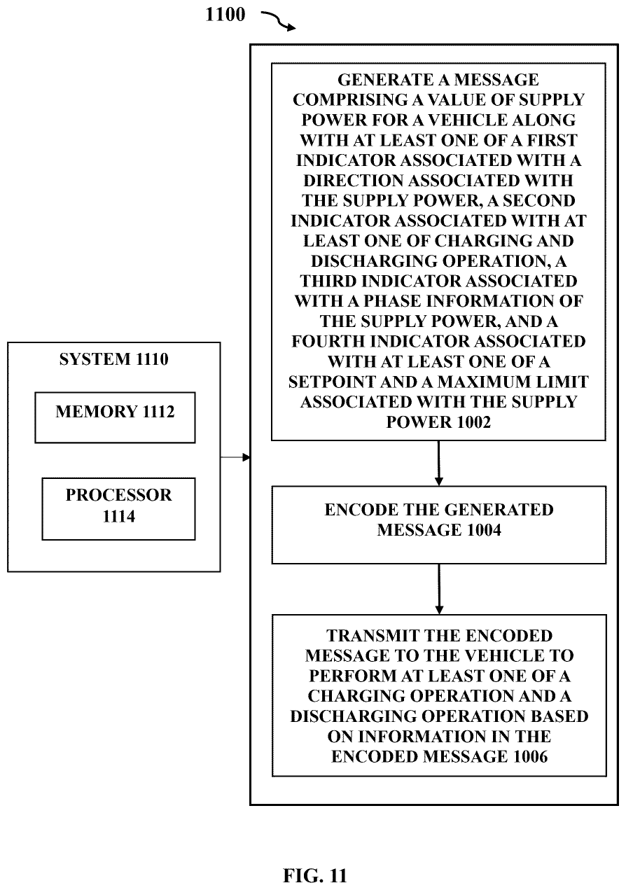

FIG. 11 illustrates block diagram 1100 of the system implementing method 1000 for communicating charging and/or discharging information according to an embodiment. According to an embodiment, disclosed is system 1110 comprising processor 1114; and memory 1112, wherein memory 1112 storing processor-executable instructions, which on execution, cause the processor to: generate, at step 1002, a message comprising a value of supply power for a vehicle along with at least one of a first indicator associated with a direction associated with the supply power, a second indicator associated with at least one of charging and discharging operation, a third indicator associated with a phase information of the supply power, and a fourth indicator associated with at least one of a set point and a maximum limit associated with the supply power, encode, at step 1004, the generated message, and transmit, at step 1006, the encoded message to the vehicle to perform at least one of a charging operation and a discharging operation based on information in the encoded message.

In some embodiments, the wherein system 1110 is a component of an Electric vehicle supply equipment (EVSE).

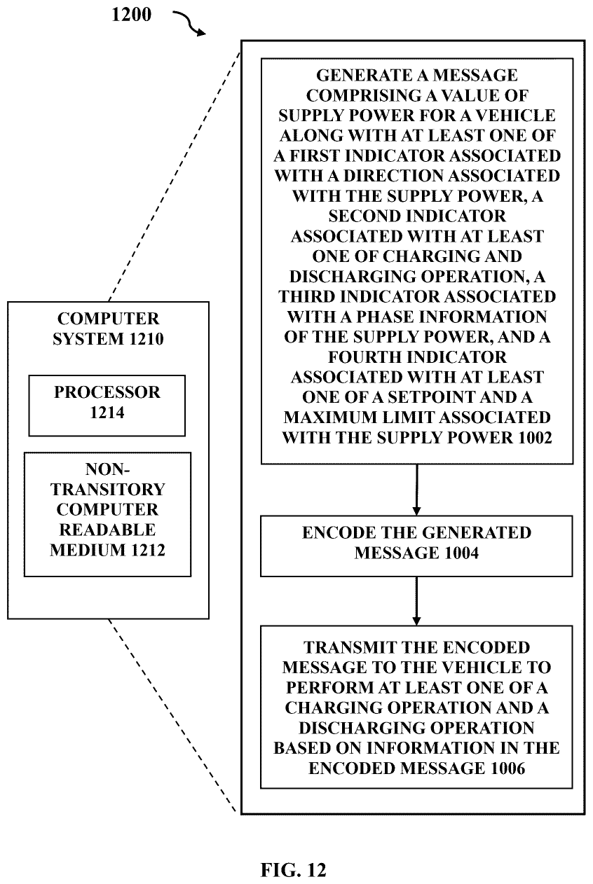

FIG. 12 illustrates block diagram 1200 of the method executed by the non-transitory computer-readable medium for communicating charging/discharging information according to an embodiment.

According to an embodiment, disclosed is computer system 1210 comprising non-transitory computer-readable medium 1212 having stored thereon instructions executable by processor 1214 to perform operations comprising: generating, at step 1002, a message comprising a value of supply power for a vehicle along with at least one of a first indicator associated with a direction of the supply power, a second indicator associated with at least one of charging and discharging operation, a third indicator associated with a phase information of the supply power, and a fourth indicator associated with at least one of a set point and a maximum limit associated with the supply power; encoding, at step 1004, the generated message; and transmitting, at step 1006, the encoded message to the vehicle to perform at least one of a charging operation and a discharging operation based on information in the encoded message.

In some embodiments, non-transitory computer-readable medium 1212 further comprises instructions to perform operations comprising: encoding at least 10-bits of the encoded message to provide an indication of a value of the supply power, wherein the encoded message comprises at least 16-bits; encoding at least 1-bit of the encoded message to provide the first indicator; encoding at least 1-bit of the encoded message to provide the second indicator; encoding at least 3-bits of the encoded message to provide the third indicator; and encoding at least 1-bit of the encoded message to provide the fourth indicator.

In some embodiments, non-transitory computer-readable medium 1212 further comprises instructions to perform operations comprising: encoding at least bits 0-9 of the encoded message to provide an indication of a value of the supply power; encoding at least bit 10 of the encoded message to provide the first indicator; encoding at least bit 11 of the encoded message to provide the second indicator; encoding at least bits 12-14 of the encoded message to provide the third indicator; and encoding at least bit 15 of the encoded message to provide the fourth indicator.

In some embodiments, non-transitory computer-readable medium 1212 further comprises instructions to perform operations comprising: encoding bit 10 of the encoded message with a value of ‘0’ to indicate at least one of a set point and a maximum limit associated with the supply power in a grid-to-vehicle (G2V) operation mode; and encoding bit 10 of the encoded message with a value of ‘1’ to indicate at least one of a set point and a maximum limit associated with the supply power in a vehicle-to-grid (V2G) operation mode.

In some embodiments, non-transitory computer-readable medium 1212 further comprises instructions to perform operations comprising encoding bit 11 of the encoded message with a value of ‘0’ to indicate the charging operation; and encoding bit 11 of the encoded message with a value of ‘1’ to indicate the discharging operation.

In some embodiments, non-transitory computer-readable medium 1212 further comprises instructions to perform operations comprising encoding bit 12 with a value of ‘1’ to indicate a first phase information associated with a first phase of the supply power, encoding bit 13 with a value of ‘1’ to indicate a second phase information associated with a second phase of the supply power, and encoding bit 14 with a value of ‘1’ to indicate a third phase information associated with a third phase of the supply power.

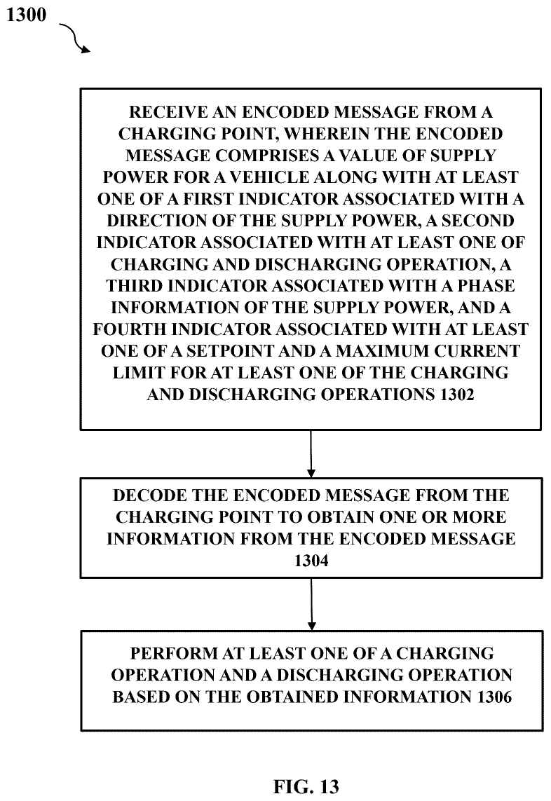

FIG. 13 illustrates a flow chart describing method 1300 for determining to perform a charging operation or a discharging operation according to an embodiment.

In some embodiments, method 1300 may be carried out by a processor using instructions stored in a memory that, when executed, cause the processor to carry out method 1300. In an embodiment, method 1300 may be performed by system 300 as shown in FIG. 3A.

Referring to FIG. 13, method 1300 may, at step 1302, receive an encoded message from a charging point, wherein the encoded message comprises a value of supply power for a vehicle along with at least one of a first indicator associated with a direction of the supply power, a second indicator associated with at least one of charging and discharging operation, a third indicator associated with a phase information of the supply power, and a fourth indicator associated with at least one of a set point and a maximum limit associated with the supply power. Method 1300 may, at step 1304, decode the encoded message from the charging point to obtain one or more information from the encoded message. Further, method 1300 may, at step 1306, perform at least one of a charging operation and a discharging operation based on the obtained information.

In some embodiments, the charging point comprises the EVSE, and the encoded message comprises a 16-bit message.

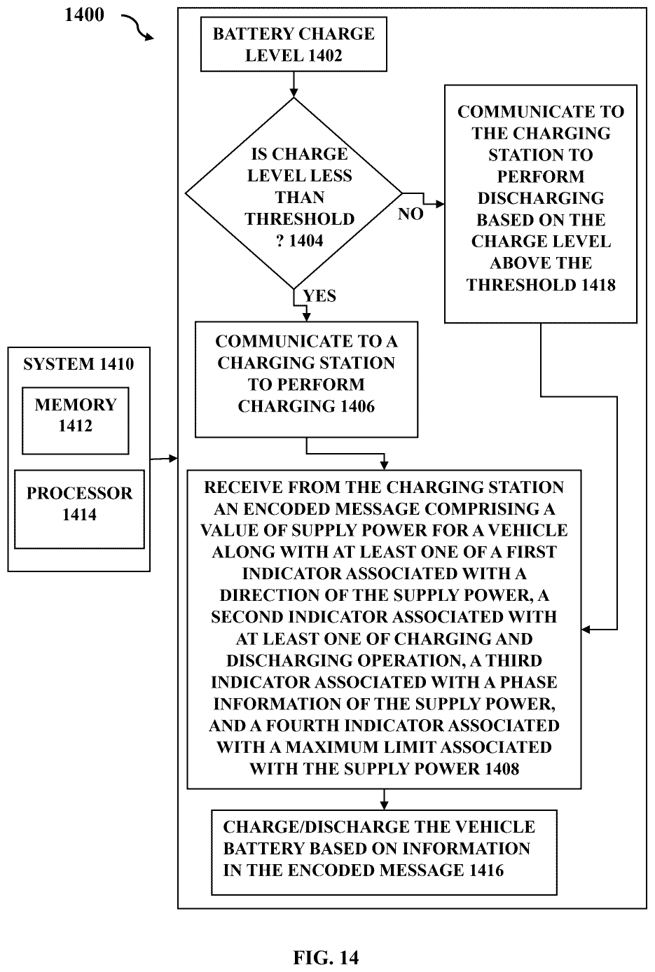

FIG. 14 illustrates block diagram 1400 of the system implementing a method for determining to perform a charging operation or a discharging operation by the vehicle according to an embodiment.

According to an embodiment, disclosed is system 1410 comprising processor 1414; and memory 1412, wherein memory 1412 storing processor-executable instructions, which on execution, cause the processor to: obtain, at step 1402, a battery charge level associated with a vehicle battery from the battery monitoring unit and determine, based on the charge level, to perform at least one of charging the vehicle battery and discharging the vehicle battery.

Referring to FIG. 14, the processor-executable instructions, which on execution, further cause the processor to determine, at step 1404, whether the battery charge level is less than a threshold, communicate, at step 1406, to a charging point to perform charging based on the charge level below a threshold, and receive, at step 1408, from the charging point an encoded message comprising a value of supply power for a vehicle along with at least one of a first indicator associated with a direction of the supply power, a second indicator associated with at least one of charging and discharging operation, a third indicator associated with a phase information of the supply power, and a fourth indicator associated with a maximum limit associated with the supply power; and charge, at step 1416, the vehicle battery based on information in the encoded message. On the other hand, communicate, at step 1418, to the charging point to perform discharging based on the charge level above the threshold; receive, at step 1416, from the charging point the encoded message comprising the value of supply power for the vehicle along with at least one of the first indicator associated with the direction of the supply power, the second indicator associated with at least one of charging and discharging operation, the third indicator associated with the phase information of the supply power, and the fourth indicator associated with the maximum limit associated with the supply power; and discharge, at step 1416, the vehicle battery based on information in the encoded message.

In some embodiments, system 1410 is a component of the vehicle. In view of the above discussions, the charging point provides an encoded message to control at least one of charging or discharging of the vehicle. In some embodiments, the vehicle may need to charge or discharge and therefore may connect to the charging point to charge/discharge. Further, the vehicle may also determine a set point, maximum limit, and a minimum limit for charging. In some embodiments, the vehicle may communicate the set point, the maximum limit, and minimum limit associated with at least one of the charging or discharging operations to the charging point through a cloud server or a centralized server. The charging point may further encode the set point, the maximum limit, and the minimum limit communicated by the vehicle and transmit the same to the vehicle to enable at least one of charging or discharging. In some embodiments, the vehicle may communicate the set point, the maximum limit, and the minimum directly to the charging point to perform at least one of charging or discharging.

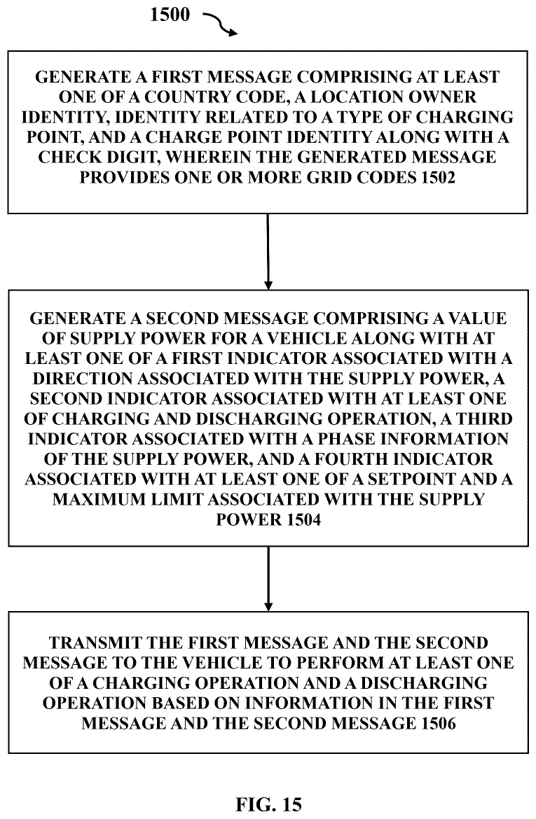

FIG. 15 illustrates a flow chart describing method 1500 of generating a first message and a second message by the charging point according to an embodiment.

In some embodiments, method 1500 may be carried out by a processor using instructions stored in a memory that, when executed, cause the processor to carry out method 1500. In an embodiment, method 1500 may be performed by system 200 as shown in FIG. 2.

Referring to FIG. 15, method 1500 may, at step 1502, generate a first message comprising at least one of a country code, a location owner identity, identity related to a type of charging point, and a charge point identity along with a check digit, wherein the generated message provides one or more grid codes. Method 1500 may, at step 1504, generate a second message comprising a value of supply power for a vehicle along with at least one of a first indicator associated with a direction associated with the supply power, a second indicator associated with at least one of charging and discharging operation, a third indicator associated with a phase information of the supply power, and a fourth indicator associated with at least one of a set point and a maximum limit associated with the supply power. Further, method 1500 may, at step 1506, transmit the first message and the second message to the vehicle to perform at least one of a charging operation and a discharging operation based on information in the first message and the second message.

In some embodiments, the first message comprises an electric vehicle supply equipment identity (EVSE ID).

In some embodiments, method 1500 may further comprise: encoding the generated second message to generate an encoded second message comprising at least 16-bits, wherein the encoded second message is based on international standards organization (ISO) 15118-2 standard.

In some embodiments, method 1500 may comprise: encoding at least 10-bits of the encoded second message to provide an indication of a value of the supply power, encoding at least 1-bit of the encoded second message to provide the first indicator; encoding at least 1-bit of the encoded second message to provide the second indicator; encoding at least 3-bits of the encoded second message to provide the third indicator; and encoding at least 1-bit of the encoded second message to provide the fourth indicator.

In some embodiments, method 1500 may further comprise: encoding at least bits 0-9 of the encoded second message to provide an indication of a value of the supply power; encoding at least bit 10 of the encoded second message to provide the first indicator; encoding at least bit 11 of the encoded second message to provide the second indicator; encoding at least bits 12-14 of the encoded second message to provide the third indicator; and encoding at least bit 15 of the encoded second message to provide the fourth indicator.

In some embodiments, method 1500 may further comprise: encoding at least 16-bits of the 40-bits of the electric vehicle supply equipment identity (EVSE ID) to provide the country code; encoding at least 8-bits of the 40-bits of the EVSE ID to provide the location owner identity; encoding at least 8-bits of the 40-bits of the EVSE ID to provide the identity related to the type of charging point; encoding at least 8-bits of the 40-bits of the EVSE ID to provide the charging point identity; and encoding at least 8-bits to provide the check digit, wherein the check digit is affixed to the EVSE ID.

In some embodiments, method 1500 may further comprise: creating a lookup table comprising the one or more grid codes associated with at least one of the country code and the check digit in the generated first message; and transmitting the created lookup table to the vehicle, wherein the lookup table enables the vehicle to determine the one or more grid codes associated with a particular location.

In some embodiments, method 1500 may further comprise: transmitting the generated first message from a charging point to the vehicle based on a connection between the charging point and the vehicle.

In some embodiments, the first indicator provides at least one of a set point and a maximum limit associated with the supply power in at least one of a grid-to-vehicle (G2V) operation mode and a vehicle-to-grid (V2G) operation mode, the second indicator indicates at least one of the vehicle performing the charging operation and the discharging operation, the third indicator provides at least one of a first phase information associated with a first phase of the supply power, a second phase information associated with a second phase of the supply power, and a third phase information associated with a third phase of the supply power and the fourth indicator provides at least one of vehicle-to-grid (V2G) set point, grid-to-vehicle (G2V) set point, V2G maximum limit, and G2V maximum limit, wherein the V2G set point, the G2V set point, the V2G maximum limit, and the G2V maximum limit are associated with the supply power.

In some embodiments, the first message is transmitted from the charging point to the vehicle based on a connection between the charging point and the vehicle and the second message is transmitted from the charging point to the vehicle based on an open systems interconnection (OSI) model, wherein the second message is transmitted to the vehicle every 120 milliseconds.

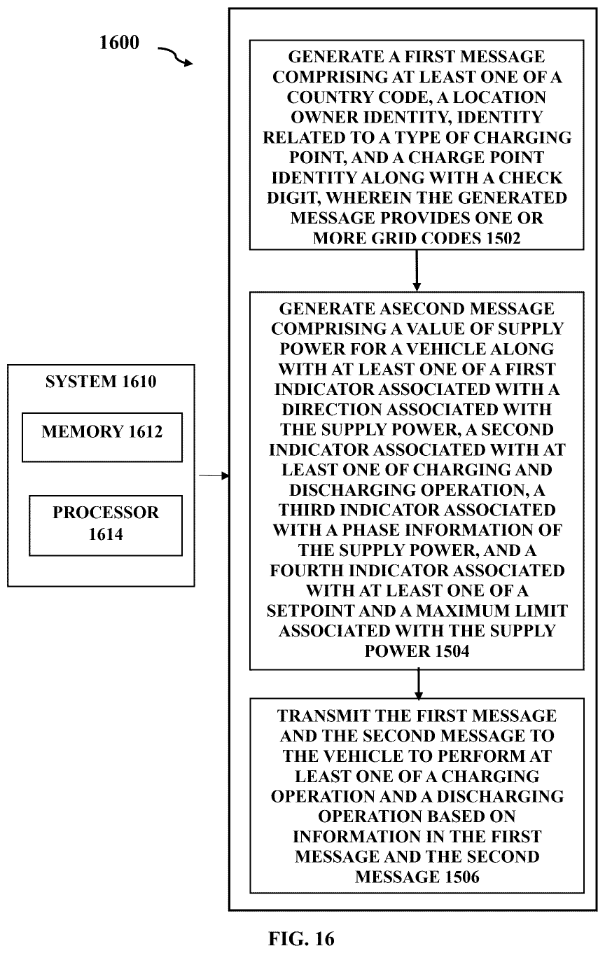

FIG. 16 illustrates block diagram 1600 of the system implementing method 1500 of generating a first message and a second message by the charging point according to an embodiment.

According to an embodiment, disclosed is system 1610 comprising processor 1614; and memory 1612, wherein memory 1612 storing processor-executable instructions, which on execution, cause the processor to: generate, at step 1502, a first message comprising at least one of a country code, a location owner identity, identity related to a type of charging point, and a charge point identity along with a check digit, wherein the generated message provides one or more grid codes; generate, at step 1504, a second message comprising a value of supply power for a vehicle along with at least one of a first indicator associated with a direction associated with the supply power, a second indicator associated with at least one of charging and discharging operation, a third indicator associated with a phase information of the supply power, and a fourth indicator associated with at least one of a set point and a maximum limit associated with the supply power; and transmit, at step 1506, the first message and the second message to the vehicle to perform at least one of a charging operation and a discharging operation based on information in the first message and the second message.

In some embodiments, the processor-executable instructions, which on execution, further cause the processor to encode the generated second message to comprise an encoded message based on international standards organization (ISO) 15118-2 standard.

In some embodiments, the first message is transmitted from the charging point to the vehicle based on a connection between the charging point and the vehicle.

In some embodiments, the second message is transmitted from the charging point to the vehicle based on an open systems interconnection (OSI) model, wherein the second message is transmitted to the vehicle every 120 milliseconds.

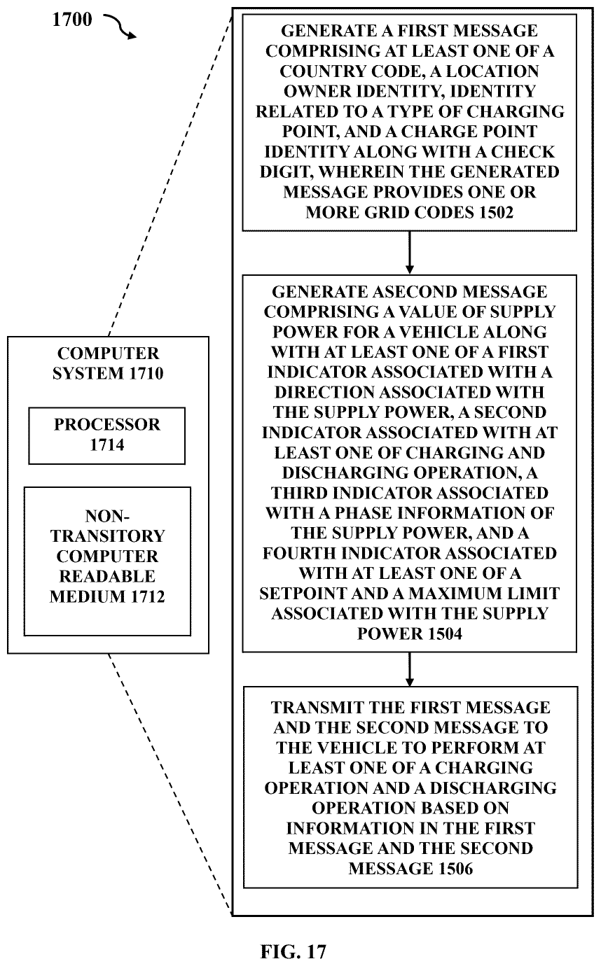

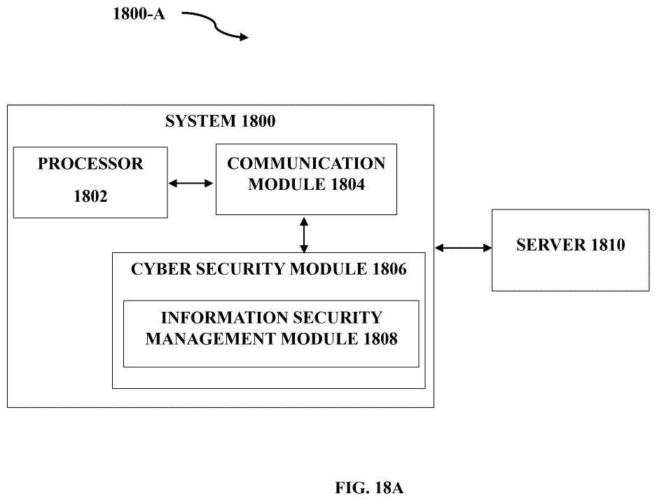

FIG. 17 illustrates block diagram 1700 of method 1500 executed by the non-transitory computer-readable medium for generating a first message and a second message by the charging point according to an embodiment.

According to an embodiment, disclosed is computer system 1710 comprising non-transitory computer-readable medium 1712 having stored thereon instructions executable by processor 1714 to perform operations comprising: generating, at step 1502, a first message comprising at least one of a country code, a location owner identity, identity related to a type of charging point, and a charge point identity along with a check digit, wherein the generated first message provides one or more grid codes; and generating, at step 1504, a second message comprising a value of supply power for a vehicle along with at least one of a first indicator associated with a direction of the supply power, a second indicator associated with at least one of charging and discharging operation, a third indicator associated with a phase information of the supply power, and a fourth indicator associated with at least one of a set point and a maximum limit associated with the supply power; and transmitting, at step 1506, the first message and the second message to the vehicle to perform at least one of a charging operation and a discharging operation based on information in the first message and the second message.

In some embodiments, non-transitory computer-readable medium 1712 further comprises instructions to perform operations comprising; encoding the generated second message to generate an encoded second message comprising at least 16-bits, wherein the encoded second message is based on international standards organization (ISO) 15118-2 standard.

In some embodiments, non-transitory computer-readable medium 1712 further comprises instructions to perform operations comprising: encoding at least 10-bits of the encoded second message to provide an indication of a value of the supply power; encoding at least 1-bit of the encoded second message to provide the first indicator; encoding at least 1-bit of the encoded second message to provide the second indicator; encoding at least 3-bits of the encoded second message to provide the third indicator; and encoding at least 1-bit of the encoded second message to provide the fourth indicator.

In some embodiments, non-transitory computer-readable medium 1712 further comprises instructions to perform operations comprising: encoding at least bits 0-9 of the encoded second message to provide an indication of a value of the supply power; encoding at least bit 10 of the encoded second message to provide the first indicator; encoding at least bit 11 of the encoded second message to provide the second indicator; encoding at least bits 12-14 of the encoded second message to provide the third indicator; and encoding at least bit 15 of the encoded second message to provide the fourth indicator.

In some embodiments, non-transitory computer-readable medium 1712 further comprises instructions to perform operations comprising: encoding at least 16-bits of the 40-bits of the electric vehicle supply equipment identity (EVSE ID) to provide the country code; encoding at least 8-bits of the 40-bits of the EVSE ID to provide the location owner identity; encoding at least 8-bits of the 40-bits of the EVSE ID to provide the identity related to the type of charging point; encoding at least 8-bits of the 40-bits of the EVSE ID to provide the charging point identity; and encoding at least 8-bits to provide the check digit, wherein the check digit is affixed to the EVSE ID.

In some embodiments, non-transitory computer-readable medium 1712 further comprises instructions to perform operations comprising creating a lookup table comprising the one or more grid codes associated with at least one of the country code and the check digit in the generated first message; and transmitting the created lookup table to the vehicle, wherein the lookup table enables the vehicle to determine the one or more grid codes associated with a particular location.

In some embodiments, non-transitory computer-readable medium 1712 further comprises instructions to perform operations comprising transmitting the generated first message from a charging point to the vehicle based on a connection between the charging point and the vehicle.

FIG. 18A shows block diagram 1800-A of a cyber security module in view of the system and server according to an embodiment.

Referring to FIG. 18A, system 1800 comprising processor 1802, communication module 1804, cyber security module 1806, and information security management module 1808 in communication with server 1810, is shown. The communication of data between system 1800 and server 1810 through communication module 1804 is first verified by information security management module 1808 before being transmitted from system 1800 to server 1810 or from server 1810 to system 1800. Information security management module 1808 is operable to analyze the data for potential cyber security threats, to encrypt the data when no cyber security threat is detected, and to transmit the data encrypted to system 1800 or server 1810.

FIG. 18B shows an embodiment of the cyber security module, in accordance with some embodiments of the present disclosure.

Referring to FIG. 18B, method 1800-B for securing the data through cyber security module 1806 is shown. At step 1812, the information security management module is operable to receive data from the communication module. At step 1814, the information security management module exchanges a security key at a start of the communication between the communication module and the server. At step 1816, the information security management module receives a security key from the server. At step 1818, the information security management module authenticates an identity of the server by verifying the security key. At step 1820, the information security management module analyzes the security key for potential cyber security threats. At step 1822, the information security management module negotiates an encryption key between the communication module and the server. At step 1824, the information security management module receives the encrypted data. At step 1826, the information security management module transmits the encrypted data to the server when no cyber security threat is detected.

FIG. 18C shows another embodiment of the cyber security module, in accordance with some embodiments of the present disclosure.

Referring to FIG. 18C, method 1800-C for securing the data through the cyber security module is shown. At step 1828, the information security management module is operable to: exchange a security key at a start of the communication between the communication module and the server. At step 1830, the information security management module receives a security key from the server. At step 1832, the information security management module authenticates an identity of the server by verifying the security key. At step 1834, the information security management module analyzes the security key for potential cyber security threats. At step 1836, the information security management module negotiates an encryption key between the communication module and the server. At step 1838, the information security management module receives encrypted data. At step 1840, information security management module 1808 decrypts the encrypted data, and performs an integrity check of the decrypted data. At step 1842, information security management module 1808 transmits the decrypted data to the communication module when no cyber security threat is detected.

In an embodiment, the integrity check is a hash-signature verification using a Secure Hash Algorithm 256 (SHA256) or a similar method. In an embodiment, the information security management module is configured to perform asynchronous authentication and validation of the communication between the communication module and the server. In an embodiment, the information security management module is configured to raise an alarm if a cyber security threat is detected. In an embodiment, the information security management module is configured to discard the encrypted data received if the integrity check of the encrypted data fails. In an embodiment, the information security management module is configured to check the integrity of the decrypted data by checking accuracy, consistency, and any possible data loss during the communication through the communication module.

In an embodiment, the server is physically isolated from the system through the information security management module. When the system communicates with the server as shown in FIG. 18A, identity authentication is first carried out on the system and then on the server. The system is responsible for communicating/exchanging a public key of the system and a signature of the public key with the server. The public key of the system and the signature of the public key are sent to the information security management module. The information security management module decrypts the signature and verifies whether the decrypted public key is consistent with the received original public key or not. If the decrypted public key is verified, the identity authentication is passed. Similarly, the system and the server carry out identity authentication on the information security management module. After the identity authentication is passed on to the information security management module, the two communication parties, the system, and the server, negotiate an encryption key and an integrity check key for data communication of the two communication parties through the authenticated asymmetric key. A session ID number is transmitted in the identity authentication process, so that the key needs to be bound with the session ID number; when the system sends data to the outside, the information security gateway receives the data through the communication module, performs integrity authentication on the data, then encrypts the data through a negotiated secret key, and finally transmits the data to the server through the communication module. When the information security management module receives data through the communication module, the data is decrypted first, integrity verification is carried out on the data after decryption, and if verification is passed, the data is sent out through the communication module; otherwise, the data is discarded.

In an embodiment, the identity authentication is realized by adopting an asymmetric key with a signature. In an embodiment, the signature is realized by a pair of asymmetric keys which are trusted by the information security management module and the system, wherein the private key is used for signing the identities of the two communication parties, and the public key is used for verifying that the identities of the two communication parties are signed. Signing identity comprises a public and a private key pair. In other words, signing identity is referred to as the common name of the certificates which are installed in the user's machine. In an embodiment, both communication parties need to authenticate their own identities through a pair of asymmetric keys, and a task in charge of communication with the information security management module of the system is identified by a unique pair of asymmetric keys. In an embodiment, the dynamic negotiation key is encrypted by adopting a Rivest-Shamir-Adleman (RSA) encryption algorithm. RSA is a public key cryptosystem that is widely used for secure data transmission. The negotiated keys include a data encryption key and a data integrity check key. In an embodiment, the data encryption method is a Triple Data Encryption Algorithm (3DES) encryption algorithm. The integrity check algorithm is a Hash-based Message Authentication Code (HMAC-MD5-128) algorithm. When data is output, the integrity check calculation is carried out on the data, the calculated Message Authentication Code (MAC) value is added with the header of the value data message, then the data (including the MAC of the header) is encrypted by using a 3DES algorithm, the header information of a security layer is added after the data is encrypted, and then the data is sent to the next layer for processing. In an embodiment the next layer refers to a transport layer in the Transmission Control Protocol/Internet Protocol (TCP/IP) model.

The information security management module ensures the safety, reliability, and confidentiality of the communication between the system and the server through the identity authentication when the communication between the two communication parties starts the data encryption and the data integrity authentication. The method is particularly suitable for an embedded platform which has less resources and is not connected with a Public Key Infrastructure (PKI) system and can ensure that the safety of the data on the server cannot be compromised by a hacker attack under the condition of the Internet by ensuring the safety and reliability of the communication between the system and the server.

In some embodiments, the communication between charging point 402 and vehicle 404 as shown in FIG. 4 may be secured by the cyber security module. Charging point 402 may include the communication module coupled to the information security management module. The charging point may send the first message and the second message to the vehicle through the communication module. The message may be verified by the information security management module before being transmitted from the charging point to the vehicle. In an embodiment, the message associated with information related to grid codes may be sent to the vehicle through the communication module and the message may be verified by the information security management module before being transmitted from the charging point to the vehicle. In another embodiment, the message associated with information related to supply power may be sent to the vehicle through the communication module and the message may be verified by the information security management module before being transmitted from the charging point to the vehicle. In some embodiments, vehicle 404 may include the communication module coupled to the information security management module. The vehicle may send the acknowledgement message to the charging point through the communication module and the acknowledgement message may be verified by the information security management module. The information security management module is operable to analyze the messages through it for potential cyber security threats, to encrypt the messages when no cyber security threat is detected, and to transmit the messages encrypted to the vehicle or the charging point.

How Technical Solution is a Technological Advancement: A detailed communication of grid codes, a maximum value of the supply power or a maximum value of current, a direction associated with the supply power or the current, a charging or discharging operation, a phase information of the supply power or current, and a set point and a maximum limit associated with the supply power or current between the charging point and the vehicle provides effective charging and discharging operations without any physical or electrical damage to the systems involved in the charging/discharging operations in comparison to the current communication of only power levels between the charging point and the vehicle.

1-78. (canceled)

79. A system comprising:
a memory storing program instructions; and
a processor coupled to the memory and executing the program instructions stored in the memory, wherein the program instructions, when executed by the processor, causes the processor to:
generate a message comprising a value of supply power for a vehicle along with at least one of a first indicator associated with a direction associated with the supply power, a second indicator associated with at least one of charging and discharging operation, a third indicator associated with a phase information of the supply power, and a fourth indicator associated with at least one of a setpoint and a maximum limit associated with the supply power;
encode the generated message; and
transmit the encoded message to the vehicle to perform at least one of a charging operation and a discharging operation based on information in the encoded message.

80. The system of claim 79, wherein the encoded message comprises at least 16-bits; and wherein at least 10-bits of the encoded message provides an indication of a value of the supply power, at least 1-bit of the encoded message provides the first indicator, at least 1-bit of the encoded message provides the second indicator, at least 3-bits of the encoded message provides the third indicator, and at least 1-bit of the encoded message provides the fourth indicator.

81. The system of claim 80, wherein at least bits 0-9 of the encoded message provides an indication of a value of the supply power.

82. The system of claim 80, wherein at least bit 10 of the encoded message provides the first indicator, wherein
a value of ‘0’ associated with bit 10 indicates at least one of a set point and a maximum limit associated with the supply power in a grid-to-vehicle (G2V) operation mode; and
a value of ‘1’ associated with bit 10 indicates at least one of a set point and a maximum limit associated with the supply power in a vehicle-to-grid (V2G) operation mode.

83. The system of claim 80, wherein at least bit 11 of the encoded message provides the second indicator, wherein a value of ‘0’ associated with bit 11 indicates the charging operation; and a value of ‘1’ associated with bit 11 indicates the discharging operation.

84. The system of claim 80, wherein at least bits 12-14 of the encoded message provide the third indicator, wherein,
bit 12 provides a first phase information associated with a first phase of the supply power;
bit 13 provides a second phase information associated with a second phase of the supply power; and
bit 14 provides a third phase information associated with a third phase of the supply power.

85. The system of claim 80, wherein at least bit 15 of the encoded message provides the fourth indicator.

86. The system of claim 80, wherein the program instructions, when executed by the processor, causes the processor to:
encode at least bits 10, 11, and 15 of the encoded message to provide at least one of vehicle-to-grid (V2G) set point, grid-to-vehicle (G2V) set point, V2G maximum limit, and G2V maximum limit, wherein the V2G set point, the G2V set point, the V2G maximum limit, and the G2V maximum limit are associated with the supply power.

87. The system of claim 86, wherein
a value of ‘0’ associated with bits 10, 11, and 15 indicates a grid-to-vehicle set point associated with the supply power;
a value of ‘0’ associated with bits 10 and 11 and a value of ‘1’ associated with bit 15 indicates a grid-to-vehicle maximum limit associated with the supply power;
a value of ‘1’ associated with bits 10 and 11 and a value of ‘0’ associated with bit 15 indicates a vehicle-to-grid setpoint associated with the supply power; and
a value of ‘1’ associated with bits 10, 11, and 15 indicates a vehicle-to-grid maximum limit associated with the supply power.

88. The system of claim 79, wherein the encoded message is based on international standards organization (ISO) 15118-2 standard.

89. The system of claim 88, wherein the encoded message is transmitted to the vehicle based on an open systems interconnection (OSI) model; and wherein the encoded message is transmitted to the vehicle over a data link layer of the OSI model.

90. The system of claim 89, wherein the encoded message is transmitted to the vehicle every 120 milliseconds.

91. The system of claim 79, wherein the system is a component of an Electric vehicle supply equipment (EVSE).

92. A method comprising:
generating a message comprising a value of supply power for a vehicle along with at least one of a first indicator associated with a direction of the supply power, a second indicator associated with at least one of charging and discharging operation, a third indicator associated with a phase information of the supply power, and a fourth indicator associated with at least one of a setpoint and a maximum current limit for at least one of the charging and discharging operations;
encoding the generated message; and
transmitting the encoded message to the vehicle to perform at least one of a charging operation and a discharging operation based on information in the encoded message.

93. The method of claim 92 further comprising;
encoding at least 10-bits of the encoded message to provide an indication of a value of the supply power, wherein the encoded message comprises at least 16-bits:
encoding at least 1-bit of the encoded message to provide the first indicator;
encoding at least 1-bit of the encoded message to provide the second indicator;
encoding at least 3-bits of the encoded message to provide the third indicator; and
encoding at least I-bit of the encoded message to provide the fourth indicator.

94. The method of claim 93 further comprising;
encoding at least bits 0-9 of the encoded message to provide an indication of a value of the supply power;
encoding at least bit 10 of the encoded message to provide the first indicator;
encoding at least bit 11 of the encoded message to provide the second indicator;
encoding at least bits 12-14 of the encoded message to provide the third indicator; and
encoding at least bit 15 of the encoded message to provide the fourth indicator.

95. The method of claim 94 further comprising:
encoding bits 10, 11, and 15 with a value of ‘0’, bit 12 with a value of ‘1’, and bits 13 and 14 with a value of ‘0’ to indicate a grid-to-vehicle set point associated with a first phase of the supply power;
encoding bits 10, 11, and 15 with a value of ‘0’, bit 13 with a value of ‘1’, and bits 12 and 14 with a value of ‘0’ to indicate a grid-to-vehicle set point associated with a second phase of the supply power;
encoding bits 10, 11, and 15 with a value of ‘0’, bit 14 with a value of ‘1’, and bits 12 and 13 with a value of ‘0’ to indicate a grid-to-vehicle set point associated with a third phase of the supply power; and
encoding bits 10, 11, and 15 with a value of ‘0’ and bits 12, 13, and 14 with a value of ‘1’ to indicate a grid-to-vehicle set point associated with all three phases of the supply power.

96. The method of claim 94 further comprising:
encoding bits 10 and 11 with a value ‘0’, bit 15 with a value ‘1’, bit 12 with a value ‘1’, and bits 13 and 14 with a value ‘0’ to indicate a grid-to-vehicle maximum limit associated with a first phase of the supply power;
encoding bits 10 and 11 with a value ‘0’, bit 15 with a value ‘1’, bit 13 with a value ‘1’, and bits 12 and 14 with a value ‘0’ to indicate a grid-to-vehicle maximum limit associated with a second phase of the supply power;
encoding bits 10 and 11 with a value ‘0’, bit 15 with a value ‘1’, bit 14 with a value ‘1’, and bits 12 and 13 with a value ‘0’ to indicate a grid-to-vehicle maximum limit associated with a third phase of the supply power; and
encoding bits 10 and 11 with a value ‘0’, bit 15 with a value ‘ 1’ and bits 12, 13, and 14 with a value ‘1’ to indicate a grid-to-vehicle maximum limit associated with all three phases of the supply power.

97. The method of claim 94 further comprising:
encoding bits 10 and 11 with a value ‘1’, bit 15 with a value ‘0’, bit 12 with a value ‘1’, and bits 13 and 14 with a value ‘0’ to indicate a vehicle-to-grid setpoint associated with a first phase of the supply power;
encoding bits 10 and 11 with a value ‘1’, bit 15 with a value ‘0’, bit 13 with a value ‘1’, and bits 12 and 14 with a value ‘0’ to indicate a vehicle-to-grid setpoint associated with a second phase of the supply power;
encoding bits 10 and 11 with a value ‘1’, bit 15 with a value ‘0’, bit 14 with a value ‘1’, and bits 12 and 13 with a value ‘0’ to indicate a vehicle-to-grid setpoint associated with a third phase of the supply power;
encoding bits 10 and 11 with a value ‘1’, bit 15 with a value ‘0’ and bits 12, 13, and 14 with a value ‘1’ to indicate a vehicle-to-grid setpoint associated with all three phases of the supply power;
encoding bits 10, 11, and 15 with a value ‘1’, bit 12 with a value ‘1’, and bits 13 and 14 with a value ‘0’ to indicate a vehicle-to-grid maximum limit associated with a first phase of the supply power;
encoding bits 10, 11, and 15 with a value ‘1’, bit 13 with a value ‘1’, and bits 12 and 14 with a value ‘0’ to indicate a vehicle-to-grid maximum limit associated with a second phase of the supply power;
encoding bits 10, 11, and 15 with a value ‘1’, bit 14 with a value ‘1’, and bits 12 and 13 with a value ‘0’ to indicate a vehicle-to-grid maximum limit associated with a third phase of the supply power; and
encoding bits 10, 11, and 15 with a value ‘1’ and bits 12, 13, and 14 with a value ‘1’ to indicate a vehicle-to-grid maximum limit associated with all three phases of the supply power.

98. A non-transitory computer-readable medium having stored thereon instructions executable by a processor to perform operations comprising:
generating a message comprising a value of supply power for a vehicle along with at least one of a first indicator associated with a direction of the supply power, a second indicator associated with at least one of charging and discharging operation, a third indicator associated with a phase information of the supply power, and a fourth indicator associated with at least one of a setpoint and a maximum current limit for at least one of the charging and discharging operations;
encoding the generated message; and
transmitting the encoded message to the vehicle to perform at least one of a charging operation and a discharging operation based on information in the encoded message.
